(19) United States
(12) Patent Application Publication
(10) Pub. No.: US 2021/0331813 A1
(43) Pub. Date: Oct. 28, 2021

(54) METHOD AND DEVICE FOR LANDING UNMANNED AERIAL VEHICLE

(71) Applicant: LG ELECTRONICS INC., Seoul (KR)

(72) Inventors: Seokhee YI, Seoul (KR); Nakyeong KIM, Seoul (KR); Sungmin MOON, Seoul (KR); Kwangho AN, Seoul (KR)

(73) Assignee: LG Electronics Inc., Seoul (KR)

(21) Appl. No.: 16/496,183

(22) PCT Filed: Sep. 3, 2019
(86) PCT No.: PCT/KR2019/011311

§ 371 Date: Sep. 20, 2019

(51) Int. Cl. B64D 45/08; B64C 39/02; B64D 27/24

(52) U.S. Cl. CPC B64D 45/08; B64C 39/024; B64D 27/24; G05D 1/102; B64C 2201/141; B64C 2201/042; B64C 2201/18

(57) ABSTRACT

The present disclosure determines whether an unmanned aerial robot is able to land in an empty area of a station as the unmanned aerial robot checks the empty space of the station or the station checks the empty space of the station, and leads the landing of the unmanned aerial robot. A drone according to the present disclosure may be associated with an artificial intelligence module, an unmanned aerial vehicle (UAV), a robot, an augmented reality (AR) device, a virtual reality (VR) device, devices related to 5G services, and the like.

### TECHNICAL FIELD

The present disclosure relates to an aerial control system of an unmanned aerial vehicle, and more particularly to an unmanned aerial vehicle and an aerial control system such that a plurality of unmanned aerial vehicles lands at one station.

### BACKGROUND ART

An unmanned aerial vehicle generally refers to an aircraft and a helicopter-shaped unmanned aerial vehicle/uninhabited aerial vehicle (UAV) capable of a flight and pilot by the induction of a radio wave without a human pilot. The unmanned aerial vehicle is recently increasingly used in various civilian and commercial fields, such as image photographing, unmanned delivery service, and disaster observation, in addition to military use such as reconnaissance and an attack.

Unmanned aerial vehicles for civilian and commercial use should be restrictively operated because construction of foundation such as various regulations, authentication and a legal system is insufficient, and it is difficult for users of unmanned aerial vehicles to recognize potential dangers or dangers that can be posed to public. Particularly, occurrence of collision accidents, flight over security areas, invasion of privacy and the like tends to increase due to indiscreet use of unmanned aerial vehicles.

Many countries are trying to improve new regulations, standards, policies and procedures with respect to operation of unmanned aerial vehicles.

In Korea, owners of ultralight flying devices are required to report it to the Ministry of Land, Infrastructure and Transport, except for non-business unmanned aerial vehicles less than 12 kg. The unmanned aerial vehicles can fly in most parts of Seoul at altitudes equal to or less than 150 m, except for a flight prohibited area and a flight restricted area near the military demarcation line (MDL). The unmanned aerial vehicles can also fly even in the flight prohibited area or the flight restricted area if approved in advance.

Various techniques have been proposed for air traffic control of unmanned aerial vehicles. Korean Patent No. 10-0954500 entitled “Air traffic control system of unmanned aerial vehicle” is configured to perform wireless communication using a unmanned aerial vehicle, on which a wireless transceiver and a code division multiple access (CDMA) modem are mounted, and a wireless communication device and control the unmanned aerial vehicle by a ground control equipment performing the wireless communication using the unmanned aerial vehicle and a CDMA communication network.

However, a related art does not disclose a technology that lands a plurality of drones smaller than a landing area of a station at the large-sized station. Thus, the related art has a disadvantage in that it is impossible to land a plurality of small-sized drones at one large-sized station or land one large-sized drone at one large-sized station.

### DISCLOSURE

### Technical Problem

A first object of the present disclosure is to provide an aerial control system capable of landing an unmanned aerial vehicle in an empty area of a part of a station in consideration of a size and a shape of the unmanned aerial vehicle.

A second object of the present disclosure is to provide an aerial control system capable of efficiently landing a plurality of unmanned aerial vehicles in a landing area without wasting the landing area in consideration of sizes and shapes of the plurality of unmanned aerial vehicles.

A third object of the present disclosure is to provide an unmanned aerial vehicle capable of selecting a landing position considering a landing position of another drone and whether landing is possible at the station by analyzing an image of a station.

A fourth object of the present disclosure is to provide an aerial control system capable of selecting landing order and a landing position in consideration of sizes, shapes, battery levels, flight schedules, etc. of the plurality of unmanned aerial vehicles.

### Technical Solution

In one aspect, there is provided an unmanned aerial vehicle comprising a camera sensor configured to obtain an image value of a station; a horizontal and vertical mobile propulsion device configured to horizontally and vertically move the unmanned aerial vehicle; a transmitter configured to transmit a radio signal; a receiver configured to receive an uplink (UL) grant and a downlink (DL) grant; and a processor configured to determine a landing area of the station through the image value of the station, compare a size of an empty area of the landing area with a size of the unmanned aerial vehicle, and determine whether the unmanned aerial vehicle is able to land in the empty area.

If the processor determines that the unmanned aerial vehicle is able to land in the empty area, the processor may cause the unmanned aerial vehicle to land in the empty area through the horizontal and vertical mobile propulsion device.

If the processor determines that the unmanned aerial vehicle is unable to land in the empty area, the processor may cause the unmanned aerial vehicle to move to another station through the horizontal and vertical mobile propulsion device.

A size of the empty area may change based on the size of the unmanned aerial vehicle.

The processor may determine whether the unmanned aerial vehicle is able to land in the empty area based on a planar shape and a planar area of a direction in which the unmanned aerial vehicle meets a ground.

If a planar shape of the empty area is larger than the planar area of the direction in which the unmanned aerial vehicle meets the ground, the processor may cause the unmanned aerial vehicle to land adjacent to an edge of the empty area through the horizontal and vertical mobile propulsion device.

In another aspect, there is provided a landing method comprising obtaining an image value of a station to land; determining whether am empty area for landing is present in the station based on the image value; if the empty area is present, comparing a size of the empty area with a size of an unmanned aerial vehicle to determine whether the landing is possible in the empty area; and if the landing is possible in the empty area, performing the landing adjacent to an edge of the empty area, wherein a size of the empty area changes based on the size of the unmanned aerial vehicle.

The landing method may further comprise transmitting a landing request signal to the station; and receiving, from the station, a landing allowance signal as a response to the landing request signal, wherein the station may prepare the landing of the unmanned aerial vehicle based on the landing request signal.

The landing method may further comprise receiving, from a network, downlink control information (DCI) used to schedule a transmission of the landing request signal, wherein the landing request signal may be transmitted to the station through the network based on the DCI.

The landing method may further comprise, if the landing is impossible in the empty area, receiving, from a server, a movement command indicating to move to another station.

The server may manage size information of the unmanned aerial vehicle.

The server may determine whether the unmanned aerial vehicle is able to land in the empty area, based on the size information.

The server may compare a planar shape and a planar area of a direction, in which the unmanned aerial vehicle meets a ground, with a planar shape and a planar area of the empty area to determine whether the unmanned aerial vehicle is able to land in the empty area.

If a size of the empty area is larger than a size of the unmanned aerial vehicle, the server may send a command that instructs the unmanned aerial vehicle to land adjacent to an edge of the empty area.

The landing method may further comprise, if the station is unable to be recognized based on the image value, transmitting a signal indicating to supply light for recognizing the station, wherein the station may include a light source for the light supply and operate the light source based on the signal.

The landing method may further comprise, if the station is unable to be recognized based on the image value, transmitting a signal indicating to operate a fan for recognizing the station, wherein the station may include the fan for blowing air to a surface of the station and operate the fan based on the signal.

The landing method may further comprise determining whether the landing is possible in the empty area based on a battery remaining amount of the unmanned aerial vehicle.

The landing method may further comprise determining whether the landing is possible in the empty area based on an amount of luggage of the unmanned aerial vehicle.

The landing method may further comprise determining whether the landing is possible in the empty area based on emergency status information of the unmanned aerial vehicle.

The landing method may further comprise determining whether the landing is possible in the empty area based on a flight schedule of the unmanned aerial vehicle.

### Advantageous Effects

The present disclosure can efficiently distribute and manage a resource of a station since one drone or a plurality of drones can land at one station.

The present disclosure can efficiently land a plurality of unmanned aerial vehicles at one station by determining a landing position in an empty area of a station considering a planar area and a planar shape of an unmanned aerial vehicle and determining a landing position in the empty area considering an area and a shape of an unmanned aerial vehicle that lands subsequently.

The present disclosure can efficiently manage a station by determining landing order of a plurality of unmanned aerial vehicles considering flight schedules, luggage, battery levels, etc. of the plurality of unmanned aerial vehicles.

The present disclosure can reduce the waste of an unmanned aerial vehicle trying to land unnecessarily and recharge quickly the unmanned aerial vehicle by previously determining whether an unmanned aerial vehicle can land at a station based on size information of the unmanned aerial vehicle and guiding the unmanned aerial vehicle to another station with an empty space when it is determined that the unmanned aerial vehicle cannot land at the station.

### DESCRIPTION OF DRAWINGS

The accompanying drawings, included as part of the detailed description in order to help understanding of the present disclosure, provide embodiments of the present disclosure and describe the technical characteristics of the present disclosure along with the detailed description.

FIG. 1 shows a perspective view of an unmanned aerial robot to which a method proposed in this specification may be applied.

FIG. 2 is a block diagram showing a control relation between major elements of the unmanned aerial vehicle of FIG. 1.

FIG. 3 is a block diagram showing a control relation between major elements of an aerial control system according to an embodiment of the present disclosure.

FIG. 4 illustrates a block diagram of a wireless communication system to which methods proposed in this specification may be applied.

FIG. 5 is a diagram showing an example of a signal transmission/reception method in a wireless communication system.

FIG. 6 shows an example of a basic operation of the robot and a 5G network in a 5G communication system.

FIG. 7 illustrates an example of a basic operation between robots using 5G communication.

FIG. 8 is a diagram showing an example of the concept diagram of a 3GPP system including a UAS.

FIG. 9 shows examples of a C2 communication model for a UAV.

FIG. 10 is a flowchart showing an example of a measurement execution method to which the present disclosure may be applied.

FIG. 11 is a block diagram illustrating a control relation between major configurations of an aerial control system according to an embodiment of the present disclosure.

FIG. 12 is a conceptual diagram illustrating a station according to the present disclosure.

FIG. 13a is a conceptual diagram illustrating a landing area of a station according to the present disclosure.

FIG. 13b is a conceptual diagram illustrating that another unmanned aerial vehicle lands in an empty area of a station according to the present disclosure.

FIG. 14 is a conceptual diagram illustrating another station according to another embodiment of the present disclosure.

FIG. 15 is a flow chart illustrating a method of controlling an unmanned aerial vehicle according to an embodiment of the present disclosure.

FIG. 16 is a flow chart illustrating a method of controlling an aerial control system according to an embodiment of the present disclosure.

FIG. 17 illustrates a block configuration diagram of a wireless communication device according to an embodiment of the present disclosure.

FIG. 18 illustrates a block configuration diagram of a communication device according to an embodiment of the present disclosure.

### MODE FOR INVENTION

Hereinafter, embodiments disclosed in this specification are described in detail with reference to the accompanying drawings. The same or similar reference numerals are assigned to the same or similar elements regardless of their reference numerals, and redundant descriptions thereof are omitted. It is to be noted that the suffixes of elements used in the following description, such as a “module” and a “unit”, are assigned or interchangeable with each other by taking into consideration only the ease of writing this specification, but in themselves are not particularly given distinct meanings and roles. Furthermore, in describing the embodiments disclosed in this specification, a detailed description of a related known technology will be omitted if it is deemed to make the gist of the present disclosure unnecessarily vague. Furthermore, the accompanying drawings are merely intended to make easily understood the exemplary embodiments disclosed in this specification, and the technical spirit disclosed in this specification is not restricted by the accompanying drawings and includes all modifications, equivalents, and substitutions which fall within the spirit and technological scope of the present disclosure.

Terms including ordinal numbers, such as the first and the second, may be used to describe various elements, but the elements are not restricted by the terms. The terms are used to only distinguish one element from the other element.

When it is said that one element is “connected” or “coupled” to the other element, it should be understood that one element may be directly connected or coupled” to the other element, but a third element may exist between the two elements. In contrast, when it is said that one element is “directly connected” or “directly coupled” to the other element, it should be understood that a third element does not exist between the two elements.

An expression of the singular number may include an expression of the plural number unless clearly defined otherwise in the context.

It is to be understood that in this application, a term, such as “include” or “have”, is intended to designate that a characteristic, number, step, operation, element, part or a combination of them described in the specification is present, and does not exclude the presence or addition possibility of one or more other characteristics, numbers, steps, operations, elements, parts, or combinations of them in advance.

Hereinafter, preferred embodiments according to the present disclosure are described in detail with reference to the accompanying drawings. The same reference numerals are assigned to the same or similar elements regardless of their reference numerals, and redundant descriptions thereof are omitted.

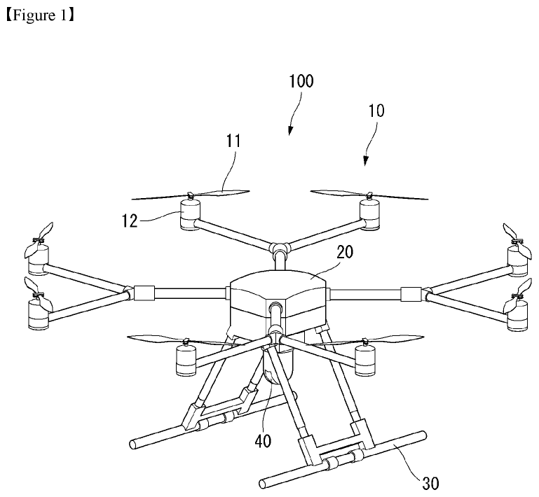

FIG. 1 shows a perspective view of an unmanned aerial robot according to an embodiment of the present disclosure.

First, the unmanned aerial vehicle (or an unmanned aerial robot) 100 is manually manipulated by an administrator on the ground, or it flies in an unmanned manner while it is automatically piloted by a configured flight program. The unmanned aerial vehicle 100, as in FIG. 1, is configured with a main body 20, the horizontal and vertical movement propulsion device 10, and landing legs 130.

The main body 20 is a body portion on which a module, such as a task unit 40, is mounted.

The horizontal and vertical movement propulsion device 10 is configured with one or more propellers 11 positioned vertically to the main body 20. The horizontal and vertical movement propulsion device 10 according to an embodiment of the present disclosure includes a plurality of propellers 11 and motors 12, which are spaced apart. In this case, the horizontal and vertical movement propulsion device 10 may have an air jet propeller structure not the propeller 11.

A plurality of propeller supports is radially formed in the main body 20. The motor 12 may be mounted on each of the propeller supports. The propeller 11 is mounted on each motor 12.

The plurality of propellers 11 may be disposed symmetrically with respect to the main body 20. Furthermore, the rotation direction of the motor 12 may be determined so that the clockwise and counterclockwise rotation directions of the plurality of propellers 11 are combined. The rotation direction of one pair of the propellers 11 symmetrical with respect to the main body 20 may be set identically (e.g., clockwise). Furthermore, the other pair of the propellers 11 may have a rotation direction opposite (e.g., counterclockwise) that of the one pair of the propellers 11.

The landing legs 30 are disposed with being spaced apart at the bottom of the main body 20. Furthermore, a buffering support member (not shown) for minimizing an impact attributable to a collision with the ground when the unmanned aerial vehicle 100 makes a landing may be mounted on the bottom of the landing leg 30. The unmanned aerial vehicle 100 may have various aerial vehicle structures different from that described above.

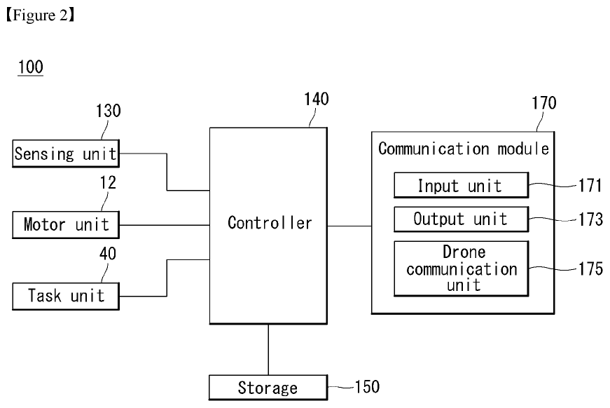

FIG. 2 is a block diagram showing a control relation between major elements of the unmanned aerial vehicle of FIG. 1.

Referring to FIG. 2, the unmanned aerial vehicle 100 measures its own flight state using a variety of types of sensors in order to fly stably. The unmanned aerial vehicle 100 may include a sensing unit 130 including at least one sensor.

The flight state of the unmanned aerial vehicle 100 is defined as rotational states and translational states.

The rotational states mean “yaw”, “pitch”, and “roll.” The translational states mean longitude, latitude, altitude, and velocity.

In this case, “roll”, “pitch”, and “yaw” are called Euler angle, and indicate that the x, y, z three axes of an aircraft body frame coordinate have been rotated with respect to a given specific coordinate, for example, three axes of NED coordinates N, E, D. If the front of an aircraft is rotated left and right on the basis of the z axis of a body frame coordinate, the x axis of the body frame coordinate has an angle difference with the N axis of the NED coordinate, and this angle is called “yaw” (Ψ). If the front of an aircraft is rotated up and down on the basis of the y axis toward the right, the z axis of the body frame coordinate has an angle difference with the D axis of the NED coordinates, and this angle is called a “pitch” (θ). If the body frame of an aircraft is inclined left and right on the basis of the x axis toward the front, the y axis of the body frame coordinate has an angle to the E axis of the NED coordinates, and this angle is called “roll” (Φ).

The unmanned aerial vehicle 100 uses 3-axis gyroscopes, 3-axis accelerometers, and 3-axis magnetometers in order to measure the rotational states, and uses a GPS sensor and a barometric pressure sensor in order to measure the translational states.

The sensing unit 130 of the present disclosure includes at least one of the gyroscopes, the accelerometers, the GPS sensor, the image sensor or the barometric pressure sensor. In this case, the gyroscopes and the accelerometers measure the states in which the body frame coordinates of the unmanned aerial vehicle 100 have been rotated and accelerated with respect to earth centered inertial coordinate. The gyroscopes and the accelerometers may be fabricated as a single chip called an inertial measurement unit (IMU) using a micro-electro-mechanical systems (MEMS) semiconductor process technology.

Furthermore, the IMU chip may include a microcontroller for converting measurement values based on the earth centered inertial coordinates, measured by the gyroscopes and the accelerometers, into local coordinates, for example, north-east-down (NED) coordinates used by GPSs.

The gyroscopes measure angular velocity at which the body frame coordinate x, y, z three axes of the unmanned aerial vehicle 100 rotate with respect to the earth centered inertial coordinates, calculate values (Wx.gyro, Wy.gyro, Wz.gyro) converted into fixed coordinates, and convert the values into Euler angles (Φgyro, θgyro, ψgyro) using a linear differential equation.

The accelerometers measure acceleration for the earth centered inertial coordinates of the body frame coordinate x, y, z three axes of the unmanned aerial vehicle 100, calculate values (fx,acc, fy,acc, fz,acc) converted into fixed coordinates, and convert the values into “roll (Φacc)” and “pitch (θacc).” The values are used to remove a bias error included in “roll (Φgyro)” and “pitch (θgyro)” using measurement values of the gyroscopes.

The magnetometers measure the direction of magnetic north points of the body frame coordinate x, y, z three axes of the unmanned aerial vehicle 100, and calculate a “yaw” value for the NED coordinates of body frame coordinates using the value.

The GPS sensor calculates the translational states of the unmanned aerial vehicle 100 on the NED coordinates, that is, a latitude (Pn.GPS), a longitude (Pe.GPS), an altitude (hMSL.GPS), velocity (Vn.GPS) on the latitude, velocity (Ve.GPS) on longitude, and velocity (Vd.GPS) on the altitude, using signals received from GPS satellites. In this case, the subscript MSL means a mean sea level (MSL).

The barometric pressure sensor may measure the altitude (hALP.baro) of the unmanned aerial vehicle 100. In this case, the subscript ALP means an air-level pressor. The barometric pressure sensor calculates a current altitude from a take-off point by comparing an air-level pressor when the unmanned aerial vehicle 100 takes off with an air-level pressor at a current flight altitude.

The camera sensor may include an image sensor (e.g., CMOS image sensor), including at least one optical lens and multiple photodiodes (e.g., pixels) on which an image is focused by light passing through the optical lens, and a digital signal processor (DSP) configuring an image based on signals output by the photodiodes. The DSP may generate a moving image including frames configured with a still image, in addition to a still image.

The unmanned aerial vehicle 100 includes a communication module 170 for inputting or receiving information or outputting or transmitting information. The communication module 170 may include a drone communication unit 175 for transmitting/receiving information to/from a different external device. The communication module 170 may include an input unit 171 for inputting information. The communication module 170 may include an output unit 173 for outputting information.

The output unit 173 may be omitted from the unmanned aerial vehicle 100, and may be formed in a terminal 300.

For example, the unmanned aerial vehicle 100 may directly receive information from the input unit 171. For another example, the unmanned aerial vehicle 100 may receive information, input to a separate terminal 300 or server 200, through the drone communication unit 175.

For example, the unmanned aerial vehicle 100 may directly output information to the output unit 173. For another example, the unmanned aerial vehicle 100 may transmit information to a separate terminal 300 through the drone communication unit 175 so that the terminal 300 outputs the information.

The drone communication unit 175 may be provided to communicate with an external server 200, an external terminal 300, etc. The drone communication unit 175 may receive information input from the terminal 300, such as a smartphone or a computer. The drone communication unit 175 may transmit information to be transmitted to the terminal 300. The terminal 300 may output information received from the drone communication unit 175.

The drone communication unit 175 may receive various command signals from the terminal 300 or/and the server 200. The drone communication unit 175 may receive area information for driving, a driving route, or a driving command from the terminal 300 or/and the server 200. In this case, the area information may include flight restriction area (A) information and approach restriction distance information.

The input unit 171 may receive On/Off or various commands. The input unit 171 may receive area information. The input unit 171 may receive object information. The input unit 171 may include various buttons or a touch pad or a microphone.

The output unit 173 may notify a user of various pieces of information. The output unit 173 may include a speaker and/or a display. The output unit 173 may output information on a discovery detected while driving. The output unit 173 may output identification information of a discovery. The output unit 173 may output location information of a discovery.

The unmanned aerial vehicle 100 includes a processor 140 for processing and determining various pieces of information, such as mapping and/or a current location. The processor 140 may control an overall operation of the unmanned aerial vehicle 100 through control of various elements that configure the unmanned aerial vehicle 100.

The processor 140 may receive information from the communication module 170 and process the information. The processor 140 may receive information from the input unit 171, and may process the information. The processor 140 may receive information from the drone communication unit 175, and may process the information.

The processor 140 may receive sensing information from the sensing unit 130, and may process the sensing information.

The processor 140 may control the driving of the motor 12. The processor 140 may control the operation of the task unit 40.

The unmanned aerial vehicle 100 includes a storage unit 150 for storing various data. The storage unit 150 records various pieces of information necessary for control of the unmanned aerial vehicle 100, and may include a volatile or non-volatile recording medium.

A map for a driving area may be stored in the storage unit 150. The map may have been input by the external terminal 300 capable of exchanging information with the unmanned aerial vehicle 100 through the drone communication unit 175, or may have been autonomously learnt and generated by the unmanned aerial vehicle 100. In the former case, the external terminal 300 may include a remote controller, a PDA, a laptop, a smartphone or a tablet on which an application for a map configuration has been mounted, for example.

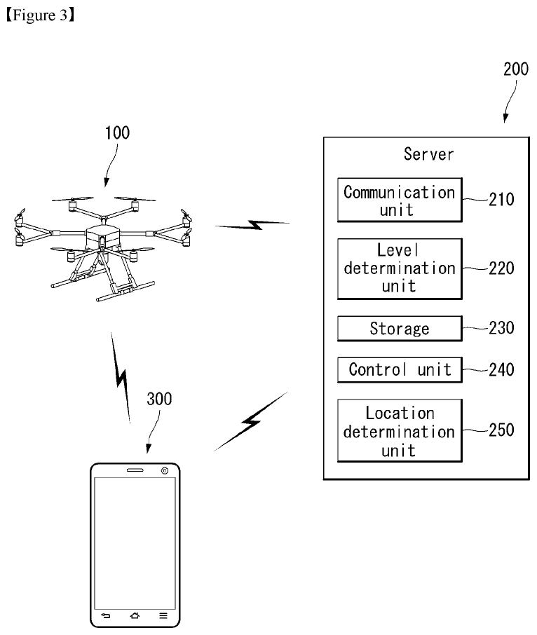

FIG. 3 is a block diagram showing a control relation between major elements of an aerial control system according to an embodiment of the present disclosure.

Referring to FIG. 3, the aerial control system according to an embodiment of the present disclosure may include the unmanned aerial vehicle 100 and the server 200, or may include the unmanned aerial vehicle 100, the terminal 300, and the server 200. The unmanned aerial vehicle 100, the terminal 300, and the server 200 are interconnected using a wireless communication method.

Global system for mobile communication (GSM), code division multi access (CDMA), code division multi access 2000 (CDMA2000), enhanced voice-data optimized or enhanced voice-data only (EV-DO), wideband CDMA (WCDMA), high speed downlink packet access (HSDPA), high speed uplink packet access (HSUPA), long term evolution (LTE), long term evolution-advanced (LTE-A), etc. may be used as the wireless communication method.

A wireless Internet technology may be used as the wireless communication method. The wireless Internet technology includes a wireless LAN (WLAN), wireless-fidelity (Wi-Fi), wireless fidelity (Wi-Fi) direct, digital living network alliance (DLNA), wireless broadband (WiBro), world interoperability for microwave access (WiMAX), high speed downlink packet access (HSDPA), high speed uplink packet access (HSUPA), long term evolution (LTE), long term evolution-advanced (LTE-A), and 5G, for example. In particular, a faster response is possible by transmitting/receiving data using a 5G communication network.

In this specification, a base station has a meaning as a terminal node of a network that directly performs communication with a terminal. In this specification, a specific operation illustrated as being performed by a base station may be performed by an upper node of the base station in some cases. That is, it is evident that in a network configured with a plurality of network nodes including a base station, various operations performed for communication with a terminal may be performed by the base station or different network nodes other than the base station. A “base station (BS)” may be substituted with a term, such as a fixed station, a Node B, an evolved-NodeB (eNB), a base transceiver system (BTS), an access point (AP), or a next generation NodeB (gNB). Furthermore, a “terminal” may be fixed or may have mobility, and may be substituted with a term, such as a user equipment (UE), a mobile station (MS), a user terminal (UT), a mobile subscriber station (MSS), a subscriber station (SS), an advanced mobile station (AMS), a wireless terminal (WT), a machine-type communication (MTC) device, a machine-to-machine (M2M) device, or a device-to-device (D2D) device.

Hereinafter, downlink (DL) means communication from a base station to a terminal. Uplink (UL) means communication from a terminal to a base station. In the downlink, a transmitter may be part of a base station, and a receiver may be part of a terminal. In the uplink, a transmitter may be part of a terminal, and a receiver may be part of a base station.

Specific terms used in the following description have been provided to help understanding of the present disclosure. The use of such a specific term may be changed into another form without departing from the technical spirit of the present disclosure.

Embodiments of the present disclosure may be supported by standard documents disclosed in at least one of IEEE 802, 3GPP and 3GPP2, that is, radio access systems. That is, steps or portions not described in order not to clearly disclose the technical spirit of the present disclosure in the embodiments of the present disclosure may be supported by the documents. Furthermore, all terms disclosed in this document may be described by the standard documents.

In order to clarity the description, 3GPP 5G is chiefly described, but the technical characteristic of the present disclosure is not limited thereto.

UE and 5G Network Block Diagram Example

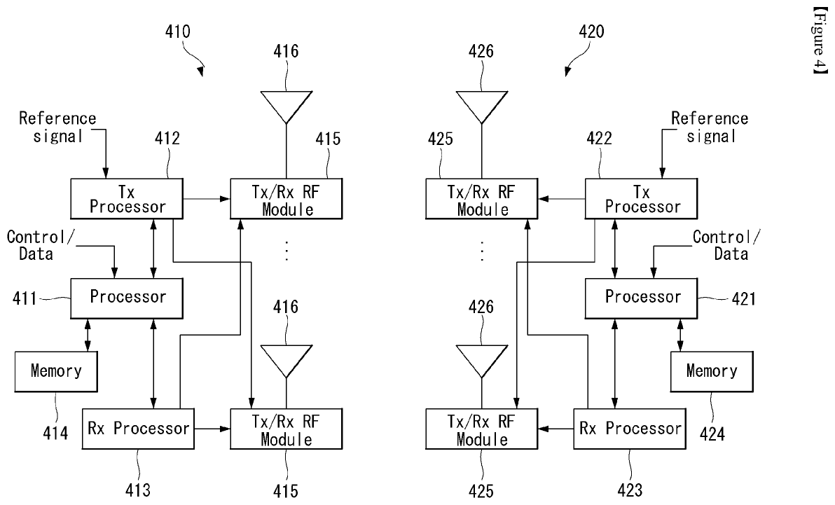

FIG. 4 illustrates a block diagram of a wireless communication system to which methods proposed in this specification may be applied.

Referring to FIG. 4, a drone is defined as a first communication device (410 of FIG. 4). A processor 411 may perform a detailed operation of the drone.

The drone may be represented as an unmanned aerial vehicle or an unmanned aerial robot.

A 5G network communicating with a drone may be defined as a second communication device (420 of FIG. 4). A processor 421 may perform a detailed operation of the drone. In this case, the 5G network may include another drone communicating with the drone.

A 5G network maybe represented as a first communication device, and a drone may be represented as a second communication device.

For example, the first communication device or the second communication device may be a base station, a network node, a transmission terminal, a reception terminal, a wireless apparatus, a wireless communication device or a drone.

For example, a terminal or a user equipment (UE) may include a drone, an unmanned aerial vehicle (UAV), a mobile phone, a smartphone, a laptop computer, a terminal for digital broadcasting, personal digital assistants (PDA), a portable multimedia player (PMP), a navigator, a slate PC, a tablet PC, an ultrabook, a wearable device (e.g., a watch type terminal (smartwatch), a glass type terminal (smart glass), and a head mounted display (HMD). For example, the HMD may be a display device of a form, which is worn on the head. For example, the HMD may be used to implement VR, AR or MR. Referring to FIG. 4, the first communication device 410, the second communication device 420 includes a processor 411, 421, a memory 414, 424, one or more Tx/Rx radio frequency (RF) modules 415, 425, a Tx processor 412, 422, an Rx processor 413, 423, and an antenna 416, 426. The Tx/Rx module is also called a transceiver. Each Tx/Rx module 415 transmits a signal each antenna 426. The processor implements the above-described function, process and/or method. The processor 421 may be related to the memory 424 for storing a program code and data. The memory may be referred to as a computer-readable recording medium. More specifically, in the DL (communication from the first communication device to the second communication device), the transmission (TX) processor 412 implements various signal processing functions for the L1 layer (i.e., physical layer). The reception (RX) processor implements various signal processing functions for the L1 layer (i.e., physical layer).

UL (communication from the second communication device to the first communication device) is processed by the first communication device 410 using a method similar to that described in relation to a receiver function in the second communication device 420. Each Tx/Rx module 425 receives a signal through each antenna 426. Each Tx/Rx module provides an RF carrier and information to the RX processor 423. The processor 421 may be related to the memory 424 for storing a program code and data. The memory may be referred to as a computer-readable recording medium.

Signal Transmission/Reception Method in Wireless Communication System

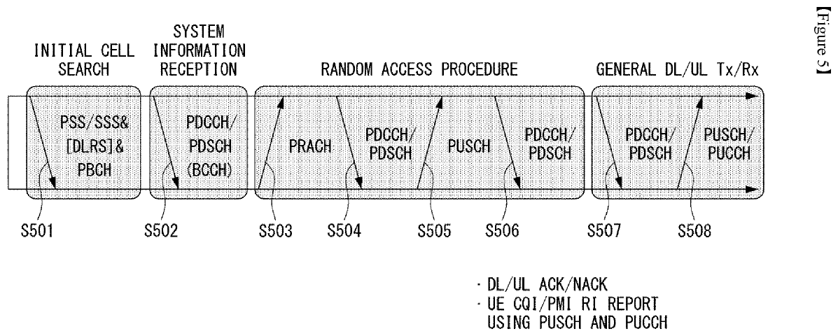

FIG. 5 is a diagram showing an example of a signal transmission/reception method in a wireless communication system.

Referring to FIG. 5, when power of a UE is newly turned on or the UE newly enters a cell, the UE performs an initial cell search task, such as performing synchronization with a BS (S501). To this end, the UE may receive a primary synchronization channel (P-SCH) and a secondary synchronization channel (S-SCH) from the BS, may perform synchronization with the BS, and may obtain information, such as a cell ID. In the LTE system and NR system, the P-SCH and the S-SCH are called a primary synchronization signal (PSS) and a secondary synchronization signal (SSS), respectively. After the initial cell search, the UE may obtain broadcast information within the cell by receiving a physical broadcast channel PBCH) form the BS. Meanwhile, the UE may identify a DL channel state by receiving a downlink reference signal (DL RS) in the initial cell search step. After the initial cell search is terminated, the UE may obtain more detailed system information by receiving a physical downlink control channel (PDCCH) and a physical downlink shared channel (PDSCH) based on information carried on the PDCCH (S502).

Meanwhile, if the UE first accesses the BS or does not have a radio resource for signal transmission, the UE may perform a random access procedure (RACH) on the BS (steps S503 to step S506). To this end, the UE may transmit a specific sequence as a preamble through a physical random access channel (PRACH) (S503 and S505), and may receive a random access response (RAR) message for the preamble through a PDSCH corresponding to a PDCCH (S504 and S506). In the case of a contention-based RACH, a contention resolution procedure may be additionally performed.

The UE that has performed the procedure may perform PDCCH/PDSCH reception (S507) and physical uplink shared channel (PUS CH)/physical uplink control channel (PUCCH) transmission (S508) as common uplink/downlink signal transmission processes. In particular, the UE receives downlink control information (DCI) through the PDCCH. The UE monitors a set of PDCCH candidates in monitoring occasions configured in one or more control element sets (CORESETs) on a serving cell based on corresponding search space configurations. A set of PDCCH candidates to be monitored by the UE is defined in the plane of search space sets. The search space set may be a common search space set or a UE-specific search space set. The CORESET is configured with a set of (physical) resource blocks having time duration of 1˜3 OFDM symbols. A network may be configured so that the UE has a plurality of CORESETs. The UE monitors PDCCH candidates within one or more search space sets. In this case, the monitoring means that the UE attempts decoding on a PDCCH candidate(s) within the search space. If the UE is successful in the decoding of one of the PDCCH candidates within the search space, the UE determines that it has detected a PDCCH in a corresponding PDCCH candidate, and performs PDSCH reception or PUSCH transmission based on DCI within the detected PDCCH. The PDCCH may be used to schedule DL transmissions on the PDSCH and UL transmissions on the PUSCH. In this case, the DCI on the PDCCH includes downlink assignment (i.e., downlink (DL) grant) related to a downlink shared channel and at least including a modulation and coding format and resource allocation information, or an uplink (DL) grant related to an uplink shared channel and including a modulation and coding format and resource allocation information.

An initial access (IA) procedure in a 5G communication system is additionally described with reference to FIG. 5.

A UE may perform cell search, system information acquisition, beam alignment for initial access, DL measurement, etc. based on an SSB. The SSB is interchangeably used with a synchronization signal/physical broadcast channel (SS/PBCH) block.

An SSB is configured with a PSS, an SSS and a PBCH. The SSB is configured with four contiguous OFDM symbols. A PSS, a PBCH, an SSS/PBCH or a PBCH is transmitted for each OFDM symbol. Each of the PSS and the SSS is configured with one OFDM symbol and 127 subcarriers. The PBCH is configured with three OFDM symbols and 576 subcarriers.

Cell search means a process of obtaining, by a UE, the time/frequency synchronization of a cell and detecting the cell identifier (ID) (e.g., physical layer cell ID (PCI)) of the cell. A PSS is used to detect a cell ID within a cell ID group. An SSS is used to detect a cell ID group. A PBCH is used for SSB (time) index detection and half-frame detection.

There are 336 cell ID groups. 3 cell IDs are present for each cell ID group. A total of 1008 cell IDs are present. Information on a cell ID group to which the cell ID of a cell belongs is provided/obtained through the SSS of the cell. Information on a cell ID among the 336 cells within the cell ID is provided/obtained through a PSS.

An SSB is periodically transmitted based on SSB periodicity. Upon performing initial cell search, SSB base periodicity assumed by a UE is defined as 20 ms. After cell access, SSB periodicity may be set as one of {5 ms, 10 ms, 20 ms, 40 ms, 80 ms, 160 ms} by a network (e.g., BS).

Next, system information (SI) acquisition is described.

SI is divided into a master information block (MIB) and a plurality of system information blocks (SIBs). SI other than the MIB may be called remaining minimum system information (RMSI). The MIB includes information/parameter for the monitoring of a PDCCH that schedules a PDSCH carrying SystemInformationBlock1 (SIB1), and is transmitted by a BS through the PBCH of an SSB. SIB1 includes information related to the availability of the remaining SIBs (hereafter, SIBx, x is an integer of 2 or more) and scheduling (e.g., transmission periodicity, SI-window size). SIBx includes an SI message, and is transmitted through a PDSCH. Each SI message is transmitted within a periodically occurring time window (i.e., SI-window).

A random access (RA) process in a 5G communication system is additionally described with reference to FIG. 5.

A random access process is used for various purposes. For example, a random access process may be used for network initial access, handover, UE-triggered UL data transmission. A UE may obtain UL synchronization and an UL transmission resource through a random access process. The random access process is divided into a contention-based random access process and a contention-free random access process. A detailed procedure for the contention-based random access process is described below.

A UE may transmit a random access preamble through a PRACH as Msg1 of a random access process in the UL. Random access preamble sequences having two different lengths are supported. A long sequence length 839 is applied to subcarrier spacings of 1.25 and 5 kHz, and a short sequence length 139 is applied to subcarrier spacings of 15, 30, 60 and 120 kHz.

When a BS receives the random access preamble from the UE, the BS transmits a random access response (RAR) message (Msg2) to the UE. A PDCCH that schedules a PDSCH carrying an RAR is CRC masked with a random access (RA) radio network temporary identifier (RNTI) (RA-RNTI), and is transmitted. The UE that has detected the PDCCH masked with the RA-RNTI may receive the RAR from the PDSCH scheduled by DCI carried by the PDCCH. The UE identifies whether random access response information for the preamble transmitted by the UE, that is, Msg1, is present within the RAR. Whether random access information for Msg1 transmitted by the UE is present may be determined by determining whether a random access preamble ID for the preamble transmitted by the UE is present. If a response for Msg1 is not present, the UE may retransmit an RACH preamble within a given number, while performing power ramping. The UE calculates PRACH transmission power for the retransmission of the preamble based on the most recent pathloss and a power ramping counter.

The UE may transmit UL transmission as Msg3 of the random access process on an uplink shared channel based on random access response information. Msg3 may include an RRC connection request and a UE identity. As a response to the Msg3, a network may transmit Msg4, which may be treated as a contention resolution message on the DL. The UE may enter an RRC connected state by receiving the Msg4.

Beam Management (BM) Procedure of 5G Communication System

A BM process may be divided into (1) a DL BM process using an SSB or CSI-RS and (2) an UL BM process using a sounding reference signal (SRS). Furthermore, each BM process may include Tx beam sweeping for determining a Tx beam and Rx beam sweeping for determining an Rx beam.

A DL BM process using an SSB is described.

The configuration of beam reporting using an SSB is performed when a channel state information (CSI)/beam configuration is performed in RRC CONNECTED.

A UE receives, from a BS, a CSI-ResourceConfig IE including CSI-SSB-ResourceSetList for SSB resources used for BM. RRC parameter csi-SSB-ResourceSetList indicates a list of SSB resources used for beam management and reporting in one resource set. In this case, the SSB resource set may be configured with {SSBx1, SSBx2, SSBx3, SSBx4, . . . }. SSB indices may be defined from 0 to 63.

The UE receives signals on the SSB resources from the BS based on the CSI-SSB-ResourceSetList.

If SSBRI and CSI-RS reportConfig related to the reporting of reference signal received power (RSRP) have been configured, the UE reports the best SSBRI and corresponding RSRP to the BS. For example, if reportQuantity of the CSI-RS reportConfig IE is configured as “ssb-Index-RSRP”, the UE reports the best SSBRI and corresponding RSRP to the BS.

If a CSI-RS resource is configured in an OFDM symbol(s) identical with an SSB and “QCL-TypeD” is applicable, the UE may assume that the CSI-RS and the SSB have been quasi co-located (QCL) in the viewpoint of “QCL-TypeD.” In this case, QCL-TypeD may mean that antenna ports have been QCLed in the viewpoint of a spatial Rx parameter. The UE may apply the same reception beam when it receives the signals of a plurality of DL antenna ports having a QCL-TypeD relation.

Next, a DL BM process using a CSI-RS is described.

An Rx beam determination (or refinement) process of a UE and a Tx beam sweeping process of a BS using a CSI-RS are sequentially described. In the Rx beam determination process of the UE, a parameter is repeatedly set as “ON.” In the Tx beam sweeping process of the BS, a parameter is repeatedly set as “OFF.”

First, the Rx beam determination process of a UE is described.

The UE receives an NZP CSI-RS resource set IE, including an RRC parameter regarding “repetition”, from a BS through RRC signaling. In this case, the RRC parameter “repetition” has been set as “ON.”

The UE repeatedly receives signals on a resource(s) within a CSI-RS resource set in which the RRC parameter “repetition” has been set as “ON” in different OFDM symbols through the same Tx beam (or DL spatial domain transmission filter) of the BS.

The UE determines its own Rx beam.

The UE omits CSI reporting. That is, if the RRC parameter “repetition” has been set as “ON”, the UE may omit CSI reporting.

Next, the Tx beam determination process of a BS is described.

A UE receives an NZP CSI-RS resource set IE, including an RRC parameter regarding “repetition”, from the BS through RRC signaling. In this case, the RRC parameter “repetition” has been set as “OFF”, and is related to the Tx beam sweeping process of the BS.

The UE receives signals on resources within a CSI-RS resource set in which the RRC parameter “repetition” has been set as “OFF” through different Tx beams (DL spatial domain transmission filter) of the BS.

The UE selects (or determines) the best beam.

The UE reports, to the BS, the ID (e.g., CRI) of the selected beam and related quality information (e.g., RSRP). That is, the UE reports, to the BS, a CRI and corresponding RSRP, if a CSI-RS is transmitted for BM.

Next, an UL BM process using an SRS is described.

A UE receives, from a BS, RRC signaling (e.g., SRS-Config IE) including a use parameter configured (RRC parameter) as “beam management.” The SRS-Config IE is used for an SRS transmission configuration. The SRS-Config IE includes a list of SRS-Resources and a list of SRS-ResourceSets. Each SRS resource set means a set of SRS-resources.

The UE determines Tx beamforming for an SRS resource to be transmitted based on SRS-SpatialRelation Info included in the SRS-Config IE. In this case, SRS-SpatialRelation Info is configured for each SRS resource, and indicates whether to apply the same beamforming as beamforming used in an SSB, CSI-RS or SRS for each SRS resource.

If SRS-SpatialRelationInfo is configured in the SRS resource, the same beamforming as beamforming used in the SSB, CSI-RS or SRS is applied, and transmission is performed. However, if SRS-SpatialRelationInfo is not configured in the SRS resource, the UE randomly determines Tx beamforming and transmits an SRS through the determined Tx beamforming.

Next, a beam failure recovery (BFR) process is described.

In a beamformed system, a radio link failure (RLF) frequently occurs due to the rotation, movement or beamforming blockage of a UE. Accordingly, in order to prevent an RLF from occurring frequently, BFR is supported in NR. BFR is similar to a radio link failure recovery process, and may be supported when a UE is aware of a new candidate beam(s). For beam failure detection, a BS configures beam failure detection reference signals in a UE. If the number of beam failure indications from the physical layer of the UE reaches a threshold set by RRC signaling within a period configured by the RRC signaling of the BS, the UE declares a beam failure. After a beam failure is detected, the UE triggers beam failure recovery by initiating a random access process on a PCell, selects a suitable beam, and performs beam failure recovery (if the BS has provided dedicated random access resources for certain beams, they are prioritized by the UE). When the random access procedure is completed, the beam failure recovery is considered to be completed.

Ultra-Reliable and Low Latency Communication (URLLC)

URLLC transmission defined in NR may mean transmission for (1) a relatively low traffic size, (2) a relatively low arrival rate, (3) extremely low latency requirement (e.g., 0.5, 1 ms), (4) relatively short transmission duration (e.g., 2 OFDM symbols), and (5) an urgent service/message. In the case of the UL, in order to satisfy more stringent latency requirements, transmission for a specific type of traffic (e.g., URLLC) needs to be multiplexed with another transmission (e.g., eMBB) that has been previously scheduled. As one scheme related to this, information indicating that a specific resource will be preempted is provided to a previously scheduled UE, and the URLLC UE uses the corresponding resource for UL transmission.

In the case of NR, dynamic resource sharing between eMBB and URLLC is supported. eMBB and URLLC services may be scheduled on non-overlapping time/frequency resources. URLLC transmission may occur in resources scheduled for ongoing eMBB traffic. An eMBB UE may not be aware of whether the PDSCH transmission of a corresponding UE has been partially punctured. The UE may not decode the PDSCH due to corrupted coded bits. NR provides a preemption indication by taking this into consideration. The preemption indication may also be denoted as an interrupted transmission indication.

In relation to a preemption indication, a UE receives a DownlinkPreemption IE through RRC signaling from a BS. When the UE is provided with the DownlinkPreemption IE, the UE is configured with an INT-RNTI provided by a parameter int-RNTI within a DownlinkPreemption IE for the monitoring of a PDCCH that conveys DCI format 2_1. The UE is configured with a set of serving cells by INT-ConfigurationPerServing Cell, including a set of serving cell indices additionally provided by servingCellID, and a corresponding set of locations for fields within DCI format 2_1 by positionInDCI, configured with an information payload size for DCI format 2_1 by dci-PayloadSize, and configured with the indication granularity of time-frequency resources by timeFrequencySect.

The UE receives DCI format 2_1 from the BS based on the DownlinkPreemption IE.

When the UE detects DCI format 2_1 for a serving cell within a configured set of serving cells, the UE may assume that there is no transmission to the UE within PRBs and symbols indicated by the DCI format 2_1, among a set of the (last) monitoring period of a monitoring period and a set of symbols to which the DCI format 2_1 belongs. For example, the UE assumes that a signal within a time-frequency resource indicated by preemption is not DL transmission scheduled therefor, and decodes data based on signals reported in the remaining resource region.

Massive MTC (mMTC)

Massive machine type communication (mMTC) is one of 5G scenarios for supporting super connection service for simultaneous communication with many UEs. In this environment, a UE intermittently performs communication at a very low transmission speed and mobility. Accordingly, mMTC has a major object regarding how long will be a UE driven how low the cost is. In relation to the mMTC technology, in 3GPP, MTC and NarrowBand (NB)-IoT are handled.

The mMTC technology has characteristics, such as repetition transmission, frequency hopping, retuning, and a guard period for a PDCCH, a PUCCH, a physical downlink shared channel (PDSCH), and a PUSCH.

That is, a PUSCH (or PUCCH (in particular, long PUCCH) or PRACH) including specific information and a PDSCH (or PDCCH) including a response for specific information are repeatedly transmitted. The repetition transmission is performed through frequency hopping. For the repetition transmission, (RF) retuning is performed in a guard period from a first frequency resource to a second frequency resource. Specific information and a response for the specific information may be transmitted/received through a narrowband (e.g., 6 RB (resource block) or 1 RB).

Robot Basic Operation Using 5G Communication

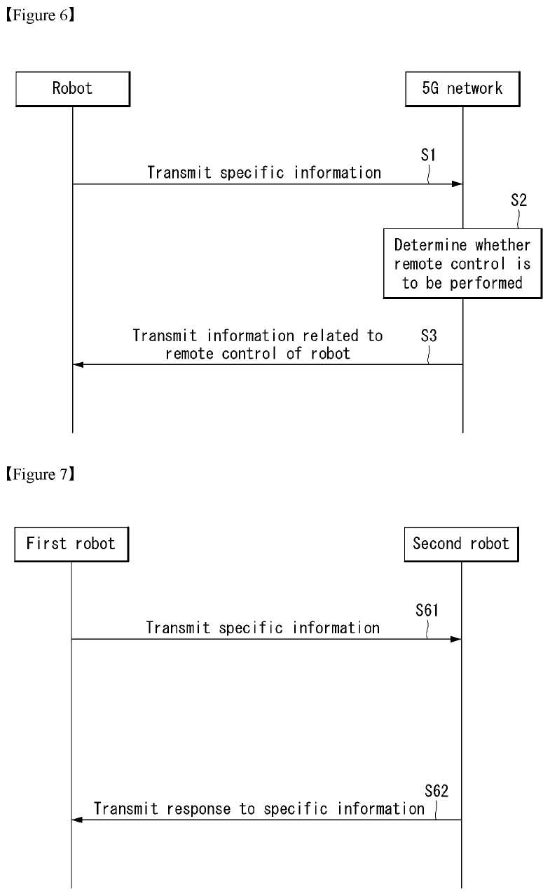

FIG. 6 shows an example of a basic operation of the robot and a 5G network in a 5G communication system.

A robot transmits specific information transmission to a 5G network (S1). Furthermore, the 5G network may determine whether the robot is remotely controlled (S2). In this case, the 5G network may include a server or module for performing robot-related remote control.

Furthermore, the 5G network may transmit, to the robot, information (or signal) related to the remote control of the robot (S3).

Application Operation Between Robot and 5G Network in 5G Communication System

Hereafter, a robot operation using 5G communication is described more specifically with reference to FIGS. 1 to 6 and the above-described wireless communication technology (BM procedure, URLLC, mMTC).

First, a basic procedure of a method to be proposed later in the present disclosure and an application operation to which the eMBB technology of 5G communication is applied is described.

As in steps S1 and S3 of FIG. 3, in order for a robot to transmit/receive a signal, information, etc. to/from a 5G network, the robot performs an initial access procedure and a random access procedure along with a 5G network prior to step S1 of FIG. 3.

More specifically, in order to obtain DL synchronization and system information, the robot performs an initial access procedure along with the 5G network based on an SSB. In the initial access procedure, a beam management (BM) process and a beam failure recovery process may be added. In a process for the robot to receive a signal from the 5G network, a quasi-co location (QCL) relation may be added.

Furthermore, the robot performs a random access procedure along with the 5G network for UL synchronization acquisition and/or UL transmission. Furthermore, the 5G network may transmit an UL grant for scheduling the transmission of specific information to the robot. Accordingly, the robot transmits specific information to the 5G network based on the UL grant. Furthermore, the 5G network transmits, to the robot, a DL grant for scheduling the transmission of a 5G processing result for the specific information. Accordingly, the 5G network may transmit, to the robot, information (or signal) related to remote control based on the DL grant.

A basic procedure of a method to be proposed later in the present disclosure and an application operation to which the URLLC technology of 5G communication is applied is described below.

As described above, after a robot performs an initial access procedure and/or a random access procedure along with a 5G network, the robot may receive a DownlinkPreemption IE from the 5G network. Furthermore, the robot receives, from the 5G network, DCI format 2_1 including pre-emption indication based on the DownlinkPreemption IE. Furthermore, the robot does not perform (or expect or assume) the reception of eMBB data in a resource (PRB and/or OFDM symbol) indicated by the pre-emption indication. Thereafter, if the robot needs to transmit specific information, it may receive an UL grant from the 5G network.

A basic procedure of a method to be proposed later in the present disclosure and an application operation to which the mMTC technology of 5G communication is applied is described below.

A portion made different due to the application of the mMTC technology among the steps of FIG. 6 is chiefly described.

In step S1 of FIG. 6, the robot receives an UL grant from the 5G network in order to transmit specific information to the 5G network. In this case, the UL grant includes information on the repetition number of transmission of the specific information. The specific information may be repeatedly transmitted based on the information on the repetition number. That is, the robot transmits specific information to the 5G network based on the UL grant. Furthermore, the repetition transmission of the specific information may be performed through frequency hopping. The transmission of first specific information may be performed in a first frequency resource, and the transmission of second specific information may be performed in a second frequency resource. The specific information may be transmitted through the narrowband of 6 resource blocks (RBs) or 1 RB.

Operation Between Robots Using 5G Communication

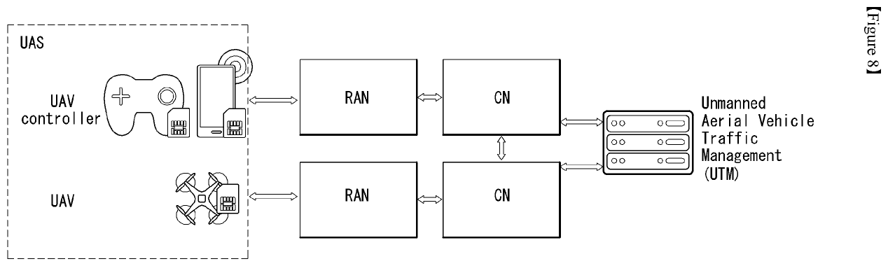

FIG. 7 illustrates an example of a basic operation between robots using 5G communication.

A first robot transmits specific information to a second robot (S61). The second robot transmits, to the first robot, a response to the specific information (S62).

Meanwhile, the configuration of an application operation between robots may be different depending on whether a 5G network is involved directly (sidelink communication transmission mode 3) or indirectly (sidelink communication transmission mode 4) in the specific information, the resource allocation of a response to the specific information.

An application operation between robots using 5G communication is described below.

First, a method for a 5G network to be directly involved in the resource allocation of signal transmission/reception between robots is described.

The 5G network may transmit a DCI format 5A to a first robot for the scheduling of mode 3 transmission (PSCCH and/or PSSCH transmission). In this case, the physical sidelink control channel (PSCCH) is a 5G physical channel for the scheduling of specific information transmission, and the physical sidelink shared channel (PSSCH) is a 5G physical channel for transmitting the specific information. Furthermore, the first robot transmits, to a second robot, an SCI format 1 for the scheduling of specific information transmission on a PSCCH. Furthermore, the first robot transmits specific information to the second robot on the PSSCH.

A method for a 5G network to be indirectly involved in the resource allocation of signal transmission/reception is described below.

A first robot senses a resource for mode 4 transmission in a first window. Furthermore, the first robot selects a resource for mode 4 transmission in a second window based on a result of the sensing. In this case, the first window means a sensing window, and the second window means a selection window. The first robot transmits, to the second robot, an SCI format 1 for the scheduling of specific information transmission on a PSCCH based on the selected resource. Furthermore, the first robot transmits specific information to the second robot on a PSSCH.

The above-described structural characteristic of the drone, the 5G communication technology, etc. may be combined with methods to be described, proposed in embodiments of the present disclosure, and may be applied or may be supplemented to materialize or clarify the technical characteristics of methods proposed in embodiments of the present disclosure.

Drone

Unmanned aerial system: a combination of a UAV and a UAV controller

Unmanned aerial vehicle: an aircraft that is remotely piloted without a human pilot, and it may be represented as an unmanned aerial robot, a drone, or simply a robot.

UAV controller: device used to control a UAV remotely

ATC: Air Traffic Control

NLOS: Non-line-of-sight

UAS: Unmanned Aerial System

UAV: Unmanned Aerial Vehicle

UCAS: Unmanned Aerial Vehicle Collision Avoidance System

UTM: Unmanned Aerial Vehicle Traffic Management

C2: Command and Control

FIG. 8 is a diagram showing an example of the concept diagram of a 3GPP system including a UAS.

An unmanned aerial system (UAS) is a combination of an unmanned aerial vehicle (UAV), sometimes called a drone, and a UAV controller. The UAV is an aircraft not including a human pilot device. Instead, the UAV is controlled by a terrestrial operator through a UAV controller, and may have autonomous flight capabilities. A communication system between the UAV and the UAV controller is provided by the 3GPP system. In terms of the size and weight, the range of the UAV is various from a small and light aircraft that is frequently used for recreation purposes to a large and heavy aircraft that may be more suitable for commercial purposes. Regulation requirements are different depending on the range and are different depending on the area.

Communication requirements for a UAS include data uplink and downlink to/from a UAS component for both a serving 3GPP network and a network server, in addition to a command and control (C2) between a UAV and a UAV controller. Unmanned aerial system traffic management (UTM) is used to provide UAS identification, tracking, authorization, enhancement and the regulation of UAS operations and to store data necessary for a UAS for an operation. Furthermore, the UTM enables a certified user (e.g., air traffic control, public safety agency) to query an identity (ID), the meta data of a UAV, and the controller of the UAV.

The 3GPP system enables UTM to connect a UAV and a UAV controller so that the UAV and the UAV controller are identified as a UAS. The 3GPP system enables the UAS to transmit, to the UTM, UAV data that may include the following control information.

Control information: a unique identity (this may be a 3GPP identity), UE capability, manufacturer and model, serial number, take-off weight, location, owner identity, owner address, owner contact point detailed information, owner certification, take-off location, mission type, route data, an operating status of a UAV.

The 3GPP system enables a UAS to transmit UAV controller data to UTM. Furthermore, the UAV controller data may include a unique ID (this may be a 3GPP ID), the UE function, location, owner ID, owner address, owner contact point detailed information, owner certification, UAV operator identity confirmation, UAV operator license, UAV operator certification, UAV pilot identity, UAV pilot license, UAV pilot certification and flight plan of a UAV controller.

The functions of a 3GPP system related to a UAS may be summarized as follows.

A 3GPP system enables the UAS to transmit different UAS data to UTM based on different certification and an authority level applied to the UAS.

A 3GPP system supports a function of expanding UAS data transmitted to UTM along with future UTM and the evolution of a support application.

A 3GPP system enables the UAS to transmit an identifier, such as international mobile equipment identity (IMEI), a mobile station international subscriber directory number (MSISDN) or an international mobile subscriber identity (IMSI) or IP address, to UTM based on regulations and security protection.

A 3GPP system enables the UE of a UAS to transmit an identity, such as an IMEI, MSISDN or IMSI or IP address, to UTM.

A 3GPP system enables a mobile network operator (MNO) to supplement data transmitted to UTM, along with network-based location information of a UAV and a UAV controller.

A 3GPP system enables MNO to be notified of a result of permission so that UTM operates.

A 3GPP system enables MNO to permit a UAS certification request only when proper subscription information is present.

A 3GPP system provides the ID(s) of a UAS to UTM.

A 3GPP system enables a UAS to update UTM with live location information of a UAV and a UAV controller.

A 3GPP system provides UTM with supplement location information of a UAV and a UAV controller.

A 3GPP system supports UAVs, and corresponding UAV controllers are connected to other PLMNs at the same time.

A 3GPP system provides a function for enabling the corresponding system to obtain UAS information on the support of a 3GPP communication capability designed for a UAS operation.

A 3GPP system supports UAS identification and subscription data capable of distinguishing between a UAS having a UAS capable UE and a USA having a non-UAS capable UE.

A 3GPP system supports detection, identification, and the reporting of a problematic UAV(s) and UAV controller to UTM.

In the service requirement of Rel-16 ID_UAS, the UAS is driven by a human operator using a UAV controller in order to control paired UAVs. Both the UAVs and the UAV controller are connected using two individual connections over a 3GPP network for a command and control (C2) communication. The first contents to be taken into consideration with respect to a UAS operation include a mid-air collision danger with another UAV, a UAV control failure danger, an intended UAV misuse danger and various dangers of a user (e.g., business in which the air is shared, leisure activities). Accordingly, in order to avoid a danger in safety, if a 5G network is considered as a transmission network, it is important to provide a UAS service by QoS guarantee for C2 communication.

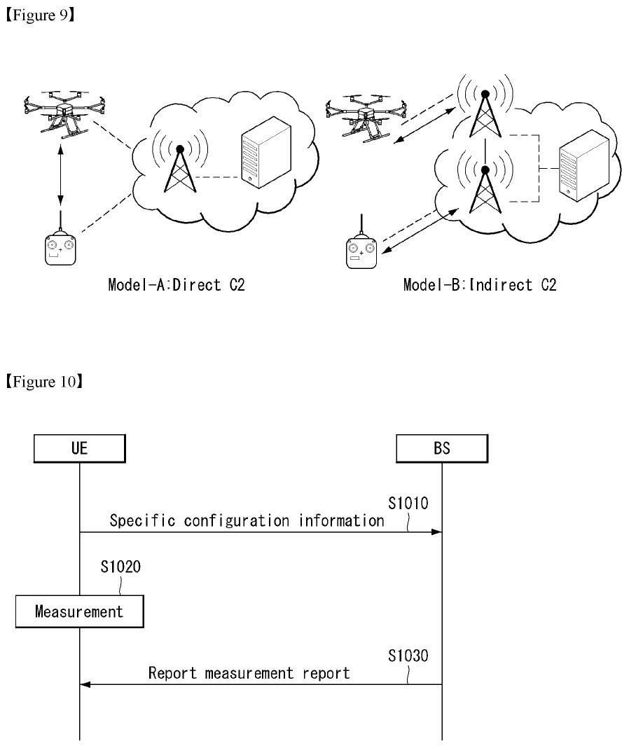

FIG. 9 shows examples of a C2 communication model for a UAV.

Model-A is direct C2. A UAV controller and a UAV directly configure a C2 link (or C2 communication) in order to communicate with each other, and are registered with a 5G network using a wireless resource that is provided, configured and scheduled by the 5G network, for direct C2 communication. Model-B is indirect C2. A UAV controller and a UAV establish and register respective unicast C2 communication links for a 5G network, and communicate with each other over the 5G network. Furthermore, the UAV controller and the UAV may be registered with the 5G network through different NG-RAN nodes. The 5G network supports a mechanism for processing the stable routing of C2 communication in any cases. A command and control use C2 communication for forwarding from the UAV controller/UTM to the UAV. C2 communication of this type (model-B) includes two different lower classes for incorporating a different distance between the UAV and the UAV controller/UTM, including a line of sight (VLOS) and a non-line of sight (non-VLOS). Latency of this VLOS traffic type needs to take into consideration a command delivery time, a human response time, and an assistant medium, for example, video streaming, the indication of a transmission waiting time. Accordingly, sustainable latency of the VLOS is shorter than that of the Non-VLOS. A 5G network configures each session for a UAV and a UAV controller. This session communicates with UTM, and may be used for default C2 communication with a UAS.

As part of a registration procedure or service request procedure, a UAV and a UAV controller request a UAS operation from UTM, and provide a pre-defined service class or requested UAS service (e.g., navigational assistance service, weather), identified by an application ID(s), to the UTM. The UTM permits the UAS operation for the UAV and the UAV controller, provides an assigned UAS service, and allocates a temporary UAS-ID to the UAS. The UTM provides a 5G network with information necessary for the C2 communication of the UAS. For example, the information may include a service class, the traffic type of UAS service, requested QoS of the permitted UAS service, and the subscription of the UAS service. When a request to establish C2 communication with the 5G network is made, the UAV and the UAV controller indicate a preferred C2 communication model (e.g., model-B) along with the UAS-ID allocated to the 5G network. If an additional C2 communication connection is to be generated or the configuration of the existing data connection for C2 needs to be changed, the 5G network modifies or allocates one or more QoS flows for C2 communication traffic based on requested QoS and priority in the approved UAS service information and C2 communication of the UAS.

UAV Traffic Management

(1) Centralized UAV Traffic Management

A 3GPP system provides a mechanism that enables UTM to provide a UAV with route data along with flight permission. The 3GPP system forwards, to a UAS, route modification information received from the UTM with latency of less than 500 ms. The 3GPP system needs to forward notification, received from the UTM, to a UAV controller having a waiting time of less than 500 ms.

(2) De-Centralized UAV Traffic Management

A 3GPP system broadcasts the following data (e.g., if it is requested based on another regulation requirement, UAV identities, UAV type, a current location and time, flight route information, current velocity, operation state) so that a UAV identifies a UAV(s) in a short-distance area for collision avoidance.

A 3GPP system supports a UAV in order to transmit a message through a network connection for identification between different UAVs. The UAV preserves owner's personal information of a UAV, UAV pilot and UAV operator in the broadcasting of identity information.

A 3GPP system enables a UAV to receive local broadcasting communication transmission service from another UAV in a short distance.

A UAV may use direct UAV versus UAV local broadcast communication transmission service in or out of coverage of a 3GPP network, and may use the direct UAV versus UAV local broadcast communication transmission service if transmission/reception UAVs are served by the same or different PLMNs.

A 3GPP system supports the direct UAV versus UAV local broadcast communication transmission service at a relative velocity of a maximum of 320 kmph. The 3GPP system supports the direct UAV versus UAV local broadcast communication transmission service having various types of message payload of 50-1500 bytes other than security-related message elements.

A 3GPP system supports the direct UAV versus UAV local broadcast communication transmission service capable of guaranteeing separation between UAVs. In this case, the UAVs may be considered to have been separated if they are in a horizontal distance of at least 50 m or a vertical distance of 30 m or both. The 3GPP system supports the direct UAV versus UAV local broadcast communication transmission service that supports the range of a maximum of 600 m.

A 3GPP system supports the direct UAV versus UAV local broadcast communication transmission service capable of transmitting a message with frequency of at least 10 message per second, and supports the direct UAV versus UAV local broadcast communication transmission service capable of transmitting a message whose inter-terminal waiting time is a maximum of 100 ms.

A UAV may broadcast its own identity locally at least once per second, and may locally broadcast its own identity up to a 500 m range.

Security

A 3GPP system protects data transmission between a UAS and UTM. The 3GPP system provides protection against the spoofing attack of a UAS ID. The 3GPP system permits the non-repudiation of data, transmitted between the UAS and the UTM, in the application layer. The 3GPP system supports the integrity of a different level and the capability capable of providing a personal information protection function with respect to a different connection between the UAS and the UTM, in addition to data transmitted through a UAS and UTM connection. The 3GPP system supports the classified protection of an identity and personal identification information related to the UAS. The 3GPP system supports regulation requirements (e.g., lawful intercept) for UAS traffic.

When a UAS requests the authority capable of accessing UAS data service from an MNO, the MNO performs secondary check (after initial mutual certification or simultaneously with it) in order to establish UAS qualification verification to operate. The MNO is responsible for transmitting and potentially adding additional data to the request so that the UAS operates as unmanned aerial system traffic management (UTM). In this case, the UTM is a 3GPP entity. The UTM is responsible for the approval of the UAS that operates and identifies the qualification verification of the UAS and the UAV operator. One option is that the UTM is managed by an aerial traffic control center. The aerial traffic control center stores all data related to the UAV, the UAV controller, and live location. When the UAS fails in any part of the check, the MNO may reject service for the UAS and thus may reject operation permission.

3GPP Support for Aerial UE (or Drone) Communication

An E-UTRAN-based mechanism that provides an LTE connection to a UE capable of aerial communication is supported through the following functions.

Subscription-based aerial UE identification and authorization defined in Section TS 23.401, 4.3.31.

Height reporting based on an event in which the altitude of a UE exceeds a reference altitude threshold configured with a network.

Interference detection based on measurement reporting triggered when the number of configured cells (i.e., greater than 1) satisfies a triggering criterion at the same time.

Signaling of flight route information from a UE to an E-UTRAN.

Location information reporting including the horizontal and vertical velocity of a UE.

(1) Subscription-Based Identification of Aerial UE Function

The support of the aerial UE function is stored in user subscription information of an HSS. The HSS transmits the information to an MME in an Attach, Service Request and Tracking Area Update process. The subscription information may be provided from the MME to a base station through an S1 AP initial context setup request during the Attach, tracking area update and service request procedure. Furthermore, in the case of X2-based handover, a source base station (BS) may include subscription information in an X2-AP Handover Request message toward a target BS. More detailed contents are described later. With respect to intra and inter MME S1-based handover, the MME provides subscription information to the target BS after the handover procedure.

(2) Height-Based Reporting for Aerial UE Communication

An aerial UE may be configured with event-based height reporting. The aerial UE transmits height reporting when the altitude of the UE is higher or lower than a set threshold. The reporting includes height and a location.

(3) Interference Detection and Mitigation for Aerial UE Communication

For interference detection, when each (per cell) RSRP value for the number of configured cells satisfies a configured event, an aerial UE may be configured with an RRM event A3, A4 or A5 that triggers measurement reporting. The reporting includes an RRM result and location. For interference mitigation, the aerial UE may be configured with a dedicated UE-specific alpha parameter for PUSCH power control.

(4) Flight Route Information Reporting

An E-UTRAN may request a UE to report flight route information configured with a plurality of middle points defined as 3D locations, as defined in TS 36.355. If the flight route information is available for the UE, the UE reports a waypoint for a configured number. The reporting may also include a time stamp per waypoint if it is configured in the request and available for the UE.

(5) Location Reporting for Aerial UE Communication

Location information for aerial UE communication may include a horizontal and vertical velocity if they have been configured. The location information may be included in the RRM reporting and the height reporting.

Hereafter, (1) to (5) of 3GPP support for aerial UE communication is described more specifically.

DL/UL Interference Detection

For DL interference detection, measurements reported by a UE may be useful. UL interference detection may be performed based on measurement in a base station or may be estimated based on measurements reported by a UE. Interference detection can be performed more effectively by improving the existing measurement reporting mechanism. Furthermore, for example, other UE-based information, such as mobility history reporting, speed estimation, a timing advance adjustment value, and location information, may be used by a network in order to help interference detection. More detailed contents of measurement execution are described later.

DL Interference Mitigation

In order to mitigate DL interference in an aerial UE, LTE Release-13 FD-MIMO may be used. Although the density of aerial UEs is high, Rel-13 FD-MIMO may be advantageous in restricting an influence on the DL terrestrial UE throughput, while providing a DL aerial UE throughput that satisfies DL aerial UE throughput requirements. In order to mitigate DL interference in an aerial UE, a directional antenna may be used in the aerial UE. In the case of a high-density aerial UE, a directional antenna in the aerial UE may be advantageous in restricting an influence on a DL terrestrial UE throughput. The DL aerial UE throughput has been improved compared to a case where a non-directional antenna is used in the aerial UE. That is, the directional antenna is used to mitigate interference in the downlink for aerial UEs by reducing interference power from wide angles. In the viewpoint that a LOS direction between an aerial UE and a serving cell is tracked, the following types of capability are taken into consideration:

1) Direction of Travel (DoT): an aerial UE does not recognize the direction of a serving cell LOS, and the antenna direction of the aerial UE is aligned with the DoT.

2) Ideal LOS: an aerial UE perfectly tracks the direction of a serving cell LOS and pilots the line of sight of an antenna toward a serving cell.

3) Non-ideal LOS: an aerial UE tracks the direction of a serving cell LOS, but has an error due to actual restriction.

In order to mitigate DL interference with aerial UEs, beamforming in aerial UEs may be used. Although the density of aerial UEs is high, beamforming in the aerial UEs may be advantageous in restricting an influence on a DL terrestrial UE throughput and improving a DL aerial UE throughput. In order to mitigate DL interference in an aerial UE, intra-site coherent TT CoMP may be used. Although the density of aerial UEs is high, the intra-site coherent TT can improve the throughput of all UEs. An LTE Release-13 coverage extension technology for non-bandwidth restriction devices may also be used. In order to mitigate DL interference in an aerial UE, a coordinated data and control transmission method may be used. An advantage of the coordinated data and control transmission method is to increase an aerial UE throughput, while restricting an influence on a terrestrial UE throughput. It may include signaling for indicating a dedicated DL resource, an option for cell muting/ABS, a procedure update for cell (re)selection, acquisition for being applied to a coordinated cell, and the cell ID of a coordinated cell.

UL Interference Mitigation

In order to mitigate UL interference caused by aerial UEs, an enhanced power control mechanisms may be used. Although the density of aerial UEs is high, the enhanced power control mechanism may be advantageous in restricting an influence on a UL terrestrial UE throughput.

The above power control-based mechanism influences the following contents.

UE-specific partial pathloss compensation factor

UE-specific Po parameter

Neighbor cell interference control parameter

Closed-loop power control

The power control-based mechanism for UL interference mitigation is described more specifically.

1) UE-Specific Partial Pathloss Compensation Factor

The enhancement of the existing open-loop power control mechanism is taken into consideration in the place where a UE-specific partial pathloss compensation factor α_{UE} is introduced. Due to the introduction of the UE-specific partial pathloss compensation factor α_{UE}, different α_{UE} may be configured by comparing an aerial UE with a partial pathloss compensation factor configured in a terrestrial UE.

2) UE-Specific P0 Parameter

Aerial UEs are configured with different Po compared with Po configured for terrestrial UEs. The enhance of the existing power control mechanism is not necessary because the UE-specific Po is already supported in the existing open-loop power control mechanism.

Furthermore, the UE-specific partial pathloss compensation factor α_{UE} and the UE-specific Po may be used in common for uplink interference mitigation. Accordingly, the UE-specific partial path loss compensation factor α_{UE} and the UE-specific Po can improve the uplink throughput of a terrestrial UE, while scarifying the reduced uplink throughput of an aerial UE.

3) Closed-Loop Power Control

Target reception power for an aerial UE is coordinated by taking into consideration serving and neighbor cell measurement reporting. Closed-loop power control for aerial UEs needs to handle a potential high-speed signal change in the sky because aerial UEs may be supported by the sidelobes of base station antennas.

In order to mitigate UL interference attributable to an aerial UE, LTE Release-13 FD-MIMO may be used. In order to mitigate UL interference caused by an aerial UE, a UE-directional antenna may be used. In the case of a high-density aerial UE, a UE-directional antenna may be advantageous in restricting an influence on an UL terrestrial UE throughput. That is, the directional UE antenna is used to reduce uplink interference generated by an aerial UE by reducing a wide angle range of uplink signal power from the aerial UE. The following type of capability is taken into consideration in the viewpoint in which an LOS direction between an aerial UE and a serving cell is tracked:

1) Direction of Travel (DoT): an aerial UE does not recognize the direction of a serving cell LOS, and the antenna direction of the aerial UE is aligned with the DoT.

2) Ideal LOS: an aerial UE perfectly tracks the direction of a serving cell LOS and pilots the line of sight of the antenna toward a serving cell.

3) Non-ideal LOS: an aerial UE tracks the direction of a serving cell LOS, but has an error due to actual restriction.

A UE may align an antenna direction with an LOS direction and amplify power of a useful signal depending on the capability of tracking the direction of an LOS between the aerial UE and a serving cell. Furthermore, UL transmission beamforming may also be used to mitigate UL interference.

Mobility

Mobility performance (e.g., a handover failure, a radio link failure (RLF), handover stop, a time in Qout) of an aerial UE is weakened compared to a terrestrial UE. It is expected that the above-described DL and UL interference mitigation technologies may improve mobility performance for an aerial UE. Better mobility performance in a rural area network than in an urban area network is monitored. Furthermore, the existing handover procedure may be improved to improve mobility performance.

Improvement of a handover procedure for an aerial UE and/or mobility of a handover-related parameter based on location information and information, such as the aerial state of a UE and a flight route plan

A measurement reporting mechanism may be improved in such a way as to define a new event, enhance a trigger condition, and control the quantity of measurement reporting.

The existing mobility enhancement mechanism (e.g., mobility history reporting, mobility state estimation, UE support information) operates for an aerial UE and may be first evaluated if additional improvement is necessary. A parameter related to a handover procedure for an aerial UE may be improved based on aerial state and location information of the UE. The existing measurement reporting mechanism may be improved by defining a new event, enhancing a triggering condition, and controlling the quantity of measurement reporting. Flight route plan information may be used for mobility enhancement.

A measurement execution method which may be applied to an aerial UE is described more specifically.

FIG. 10 is a flowchart showing an example of a measurement execution method to which the present disclosure may be applied.

An aerial UE receives measurement configuration information from a base station (S1010). In this case, a message including the measurement configuration information is called a measurement configuration message. The aerial UE performs measurement based on the measurement configuration information (S1020). If a measurement result satisfies a reporting condition within the measurement configuration information, the aerial UE reports the measurement result to the base station (S1030). A message including the measurement result is called a measurement report message. The measurement configuration information may include the following information.

(1) Measurement object information: this is information on an object on which an aerial UE will perform measurement. The measurement object includes at least one of an intra-frequency measurement object that is an object of measurement within a cell, an inter-frequency measurement object that is an object of inter-cell measurement, or an inter-RAT measurement object that is an object of inter-RAT measurement. For example, the intra-frequency measurement object may indicate a neighbor cell having the same frequency band as a serving cell. The inter-frequency measurement object may indicate a neighbor cell having a frequency band different from that of a serving cell. The inter-RAT measurement object may indicate a neighbor cell of an RAT different from the RAT of a serving cell.

(2) Reporting configuration information: this is information on a reporting condition and reporting type regarding when an aerial UE reports the transmission of a measurement result. The reporting configuration information may be configured with a list of reporting configurations. Each reporting configuration may include a reporting criterion and a reporting format. The reporting criterion is a level in which the transmission of a measurement result by a UE is triggered. The reporting criterion may be the periodicity of measurement reporting or a single event for measurement reporting. The reporting format is information regarding that an aerial UE will configure a measurement result in which type.

An event related to an aerial UE includes (i) an event H1 and (ii) an event H2.

Event H1 (Aerial UE Height Exceeding a Threshold)

A UE considers that an entering condition for the event is satisfied when 1) the following defined condition H1-1 is satisfied, and considers that a leaving condition for the event is satisfied when 2) the following defined condition H1-2 is satisfied.

Ms−Hys>Thresh+Offset Inequality H1-1 (entering condition)

Ms+Hys<Thresh+Offset Inequality H1-2 (leaving condition)

In the above equation, the variables are defined as follows.

Ms is an aerial UE height and does not take any offset into consideration. Hys is a hysteresis parameter (i.e., h1-hysteresis as defined in ReportConfigEUTRA) for an event. Thresh is a reference threshold parameter variable for the event designated in MeasConfig (i.e., heightThreshRef defined within MeasConfig). Offset is an offset value for heightThreshRef for obtaining an absolute threshold for the event (i.e., h1-ThresholdOffset defined in ReportConfigEUTRA). Ms is indicated in meters. Thresh is represented in the same unit as Ms.

Event H2 (Aerial UE Height of Less than Threshold)

A UE considers that an entering condition for an event is satisfied 1) the following defined condition H2-1 is satisfied, and considers that a leaving condition for the event is satisfied 2) when the following defined condition H2-2 is satisfied.

Ms+Hys<Thresh+Offset Inequality H2-1 (entering condition)

Ms−Hys>Thresh+Offset Inequality H2-2 (leaving condition)

In the above equation, the variables are defined as follows.

Ms is an aerial UE height and does not take any offset into consideration. Hys is a hysteresis parameter (i.e., h1-hysteresis as defined in ReportConfigEUTRA) for an event. Thresh is a reference threshold parameter variable for the event designated in MeasConfig (i.e., heightThreshRef defined within MeasConfig). Offset is an offset value for heightThreshRef for obtaining an absolute threshold for the event (i.e., h2-ThresholdOffset defined in ReportConfigEUTRA). Ms is indicated in meters. Thresh is represented in the same unit as Ms.

(3) Measurement identity information: this is information on a measurement identity by which an aerial UE determines to report which measurement object using which type by associating the measurement object and a reporting configuration. The measurement identity information is included in a measurement report message, and may indicate that a measurement result is related to which measurement object and that measurement reporting has occurred according to which reporting condition.

(4) Quantity configuration information: this is information on about a parameter for configuration of measurement unit, reporting unit and/or filtering of measurement result value.

(5) Measurement gap information: this is information on a measurement gap, that is, an interval which may be used by an aerial UE in order to perform only measurement without taking into consideration data transmission with a serving cell because downlink transmission or uplink transmission has not been scheduled in the aerial UE.

In order to perform a measurement procedure, an aerial UE has a measurement object list, a measurement reporting configuration list, and a measurement identity list. If a measurement result of the aerial UE satisfies a configured event, the UE transmits a measurement report message to a base station.

In this case, the following parameters may be included in a UE-EUTRA-Capability Information Element in relation to the measurement reporting of the aerial UE. IE UE-EUTRA-Capability is used to forward, to a network, an E-RA UE Radio Access Capability parameter and a function group indicator for an essential function. IE UE-EUTRA-Capability is transmitted in an E-UTRA or another RAT. Table 1 is a table showing an example of the UE-EUTRA-Capability IE.

TABLE 1
-- ASN1START..... MeasParameters-v1530 ::= SEQUENCE {qoe-MeasReport-r15
ENUMERATED {supported} OPTIONAL, qoe-MTSI-MeasReport-r15
ENUMERATED {supported} OPTIONAL, ca-IdleModeMeasurements-r15
ENUMERATED {supported} OPTIONAL, ca-IdleModeValidityArea-r15
ENUMERATED {supported} OPTIONAL, heightMeas-r15 ENUMERATED
{supported} OPTIONAL, multipleCellsMeasExtension-r15 ENUMERATED
{supported} OPTIONAL}.....

The heightMeas-r15 field defines whether a UE supports height-based measurement reporting defined in TS 36.331. As defined in TS 23.401, to support this function with respect to a UE having aerial UE subscription is essential. The multipleCellsMeasExtension-r15 field defines whether a UE supports measurement reporting triggered based on a plurality of cells. As defined in TS 23.401, to support this function with respect to a UE having aerial UE subscription is essential.

UAV UE Identification

A UE may indicate a radio capability in a network which may be used to identify a UE having a related function for supporting a UAV-related function in an LTE network. A permission that enables a UE to function as an aerial UE in the 3GPP network may be aware based on subscription information transmitted from the MME to the RAN through S1 signaling. Actual “aerial use” certification/license/restriction of a UE and a method of incorporating it into subscription information may be provided from a Non-3GPP node to a 3GPP node. A UE in flight may be identified using UE-based reporting (e.g., mode indication, altitude or location information during flight, an enhanced measurement reporting mechanism (e.g., the introduction of a new event) or based on mobility history information available in a network.

Subscription Handling for Aerial UE

The following description relates to subscription information processing for supporting an aerial UE function through the E-UTRAN defined in TS 36.300 and TS 36.331. An eNB supporting aerial UE function handling uses information for each user, provided by the MME, in order to determine whether the UE can use the aerial UE function. The support of the aerial UE function is stored in subscription information of a user in the HSS. The HSS transmits the information to the MME through a location update message during an attach and tracking area update procedure. A home operator may cancel the subscription approval of the user for operating the aerial UE at any time. The MME supporting the aerial UE function provides the eNB with subscription information of the user for aerial UE approval through an S1 AP initial context setup request during the attach, tracking area update and service request procedure.

An object of an initial context configuration procedure is to establish all required initial UE context, including E-RAB context, a security key, a handover restriction list, a UE radio function, and a UE security function. The procedure uses UE-related signaling.

In the case of Inter-RAT handover to intra- and inter-MME S1 handover (intra RAT) or E-UTRAN, aerial UE subscription information of a user includes an S1-AP UE context modification request message transmitted to a target BS after a handover procedure.

An object of a UE context change procedure is to partially change UE context configured as a security key or a subscriber profile ID for RAT/frequency priority, for example. The procedure uses UE-related signaling.

In the case of X2-based handover, aerial UE subscription information of a user is transmitted to a target BS as follows:

If a source BS supports the aerial UE function and aerial UE subscription information of a user is included in UE context, the source BS includes corresponding information in the X2-AP handover request message of a target BS.

An MME transmits, to the target BS, the aerial UE subscription information in a Path Switch Request Acknowledge message.

An object of a handover resource allocation procedure is to secure, by a target BS, a resource for the handover of a UE.

If aerial UE subscription information is changed, updated aerial UE subscription information is included in an S1-AP UE context modification request message transmitted to a BS.

Table 2 is a table showing an example of the aerial UE subscription information.

TABLE 2

| | | | |
|---|---|---|---|
| IE/Group Name | Presence | Range | IE type and reference |

| | | |
|---|---|---|
| Aerial UE | M | ENUMERATED (allowed, |
| subscription | | not allowed, . . .) |
| information | | |

Aerial UE subscription information is used by a BS in order to know whether a UE can use the aerial UE function.

Combination of Drone and eMBB

A 3GPP system can support data transmission for a UAV (aerial UE or drone) and for an eMBB user at the same time.

A base station may need to support data transmission for an aerial UAV and a terrestrial eMBB user at the same time under a restricted bandwidth resource. For example, in a live broadcasting scenario, a UAV of 100 meters or more requires a high transmission speed and a wide bandwidth because it has to transmit, to a base station, a captured figure or video in real time. At the same time, the base station needs to provide a requested data rate to terrestrial users (e.g., eMBB users). Furthermore, interference between the two types of communications needs to be minimized.

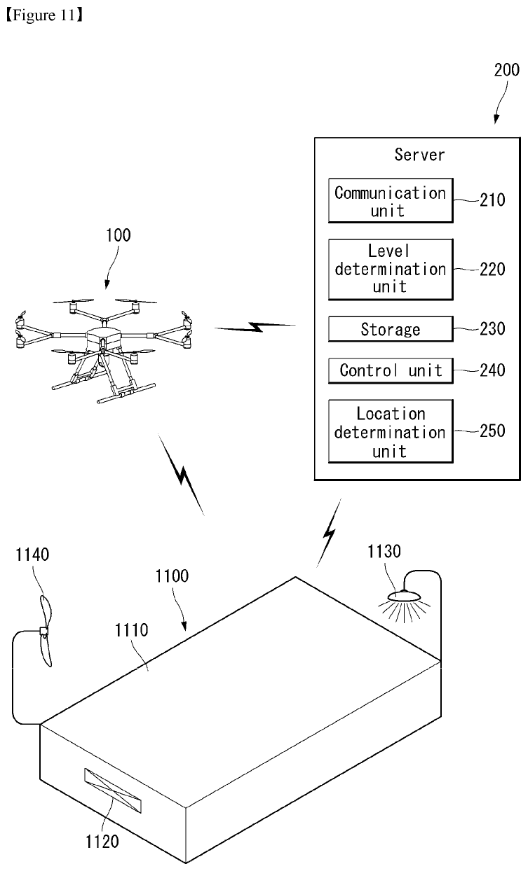

Referring to FIG. 11, an aerial control system according to an embodiment of the present disclosure may include an unmanned aerial vehicle 100 and a server 200, or may include an unmanned aerial vehicle 100, a station 1100, and a server 200. The unmanned aerial vehicle 100, the station 1100, and the server 200 are connected through different wireless communication methods.

Examples of the wireless communication methods may include GSM (Global System for Mobile communication), CDMA (Code Division Multi Access), CDMA2000 (Code Division Multi Access 2000), EV-DO (Enhanced Voice-Data Optimized or Enhanced Voice-Data Only), WCDMA (Wideband CDMA), HSDPA (High Speed Downlink Packet Access), HSUPA (High Speed Uplink Packet Access), LTE (Long Term Evolution), LTE-A (Long Term Evolution-Advanced), and the like.

The wireless communication method may use a wireless Internet technology. Examples of the wireless Internet technology may include WLAN (Wireless LAN), Wi-Fi (Wireless-Fidelity), Wi-Fi (Wireless Fidelity) Direct, DLNA (Digital Living Network Alliance), WiBro (Wireless Broadband), WiMAX (World Interoperability for Microwave Access), HSDPA (High Speed Downlink Packet Access), HSUPA (High Speed Uplink Packet Access), LTE (Long Term Evolution), LTE-A (Long Term Evolution-Advanced), 5G, and the like. In particular, faster response is possible by transmitting and receiving data using a 5G communication network.

The station 1100 may include a landing area 1110 that is a space where the unmanned aerial vehicle 100 lands, and a power supply unit 1120 that supplies power to the unmanned aerial vehicle 100 landing in the landing area 1110. A control unit 240 to be described later may be included in the station 1100, or included in the server 200.

An area sensing sensor that senses an occupied area 1111 and an empty area 1113 of the landing area 1110 may be installed in the station 1100. The area sensing sensor may include a sensor sensing an object. Examples of the area sensing sensor may include a distance sensor, an obstacle sensor, a laser sensor, an ultrasonic sensor, an image sensor, etc. Specifically, a plurality of area sensing sensors may be installed at a regular pitch in the landing area 1110. As another example, the area sensing sensor may be included in a camera taking an image of the landing area 1110, and may analyze an image obtained by the camera and determine the occupied area 1111 and the empty area 1113.

The present disclosure may further include a fan 1140 and a light source 1130. The light source 1130 provides light to the station 1100. The light source 1130 provides light to the station 1100 when it is too dark for the unmanned aerial vehicle 100 to acquire an image of the station 1100.

The control unit 240 may control to turn on the light source 1130 if the control unit 240 receives, from the unmanned aerial vehicle 100, a signal indicating that recognition of the station 1100 is impossible.

The fan 1140 provides an air current to the station 1100. The control unit 240 may control to turn on the fan 1140 if the control unit 240 receives, from the unmanned aerial vehicle 100, a signal indicating that recognition of the station 1100 is impossible. The fan 1140 function to remove fog or smoke around the station 1100.

The server 200 stores information on a flight restricted area in which a flight of the unmanned aerial vehicle 100 is restricted, differently calculates an access limit distance of the flight restricted area depending on an autonomous flying level of the unmanned aerial vehicle 100, and provides information on the flight restricted area and information on the access limit distance to the unmanned aerial vehicle 100. Thus, the server 200 enables the unmanned aerial vehicle 100 with a high autonomous flying level to fly along an effective path and can prevent an accident that may occur when the unmanned aerial vehicle 100 with a low autonomous flying level approaches the flight restricted area.

The server 200 may set a flight path based on information on the flight restricted area and information on the access limit distance and provide the flight path to the unmanned aerial vehicle 100.

Actively, the server 200 may set a flight path based on information on the flight restricted area and information on the access limit distance depending on the autonomous flying level and control the unmanned aerial vehicle 100 along the flight path.

The server 200 may send different commands to the unmanned aerial vehicle 100 depending on the autonomous flying level if the unmanned aerial vehicle 100 approaches within the access limit distance. The server 200 may send different commands to the unmanned aerial vehicle 100 depending on whether the unmanned aerial vehicle 100 is automatically or manually adjusted.

A storage 230 may store information on the flight restricted area, information on the autonomous flying level of the unmanned aerial vehicle 100, and information on aerial control of the unmanned aerial vehicle 100, for the purpose of the aerial control.

The storage 230 may store shape information and planar area information of each unmanned aerial vehicle 100 and store an identification code of the unmanned aerial vehicle 100.

A level determination unit 220 determines the autonomous flying level of the unmanned aerial vehicle 100. The level determination unit 220 determines the autonomous flying level of the unmanned aerial vehicle 100 through information on the autonomous flying level transmitted from the unmanned aerial vehicle 100 to the server 200.

The autonomous flying level of the unmanned aerial vehicle 100 may include level 1 at which only a completely manual flying is allowed or the manual flying is assisted by various sensors, level 2 at which the unmanned aerial vehicle 100 performs a semi-autonomous flying (automatic takeoff and landing, passive obstacle avoidance, movement along a path designated by a user), and level 3 at which the unmanned aerial vehicle 100 performs a completely autonomous flying (that creates a path by itself, moves to a destination, and performs an operation by itself).

The control unit 240 differently calculates an access limit distance of the flight restricted area depending on the autonomous flying level of the unmanned aerial vehicle 100 and provides information on the flight restricted area and information on the access limit distance to the unmanned aerial vehicle 100 and/or the station 1100.

Here, providing information, commands, or signals of the control unit 240 to the unmanned aerial vehicle 100 and/or the station 1100 means that transmission of information data to the unmanned aerial vehicle 100 and/or the station 1100 through a wireless communication method such as 5G.

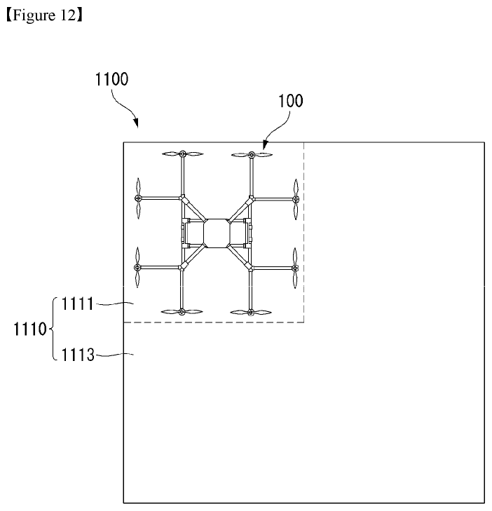

Referring to FIG. 12, the landing area 1110 refers to an area in which the unmanned aerial vehicle 100 can land among the station 1100. The empty area 1113 refers to an area in which other unmanned aerial vehicle 100 does not land among the landing area 1110. The occupied area 1111 refers to an area that the unmanned aerial vehicle 100 occupies through the landing among the landing area 1110.

The following describes that a processor 140 or the control unit 240 of the unmanned aerial vehicle 100 divides the empty area 1113 into a plurality of subareas and selects a landing position of a small-sized unmanned aerial vehicle 100 through the division.

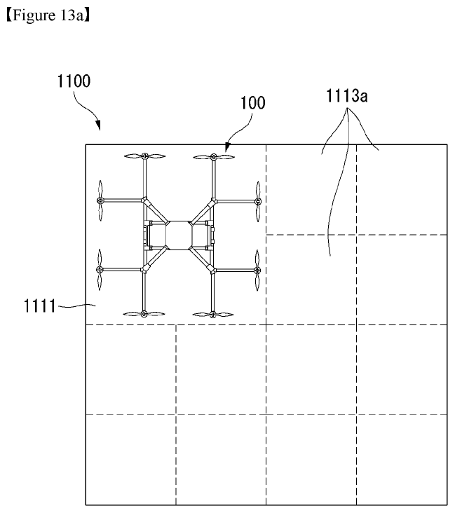

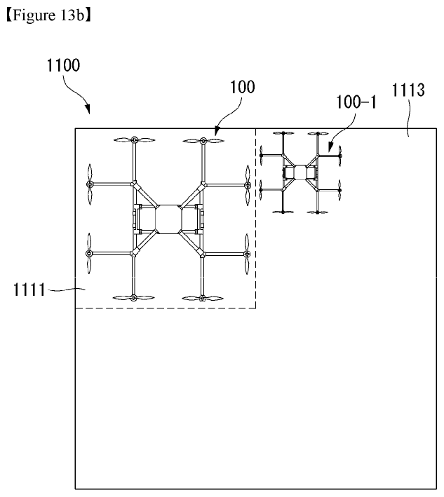

Referring to FIG. 13a, a first unmanned aerial vehicle 100 may land in a part of a landing area 1110, and the landing area 1110 includes an occupied area 1111 and an empty area 1113a. The processor 140 or the control unit 240 of the unmanned aerial vehicle 100 may divide the empty area 1113a into a plurality of logically virtual subareas, select a landing position in an area adjacent to an edge of the empty area 1113a if a relatively small-sized unmanned aerial vehicle 100 has to land, and select a landing position in consideration of a shape and size of other unmanned aerial vehicle 100 that will land subsequently. To this end, the server may manage scheduling information, etc. of other unmanned aerial vehicles 100 to land subsequently and share it with the unmanned aerial vehicles 100.

Hence, the present disclosure enables a large number of unmanned aerial vehicles 100 to land by efficiently using a space of the landing area 1110 of the station 1100.

Referring to FIG. 13b, the processor 140 or the control unit 240 of the unmanned aerial vehicle 100 may select a landing position in a part of an empty area 1113 that is adjacent to an edge of the empty area 1113 and is adjacent to a first unmanned aerial vehicle 100, and a second unmanned aerial vehicle 100-1 may land at a landing position, in the empty area 1113, that is adjacent to the edge of the empty area 1113 and is adjacent to the first unmanned aerial vehicle 100.

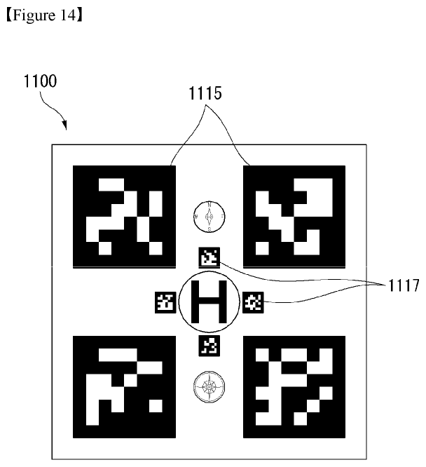

Referring to FIG. 14, an identification mark assisting the landing of the unmanned aerial vehicle 100 may be disposed in the landing area 1110 of the station 1100. A plurality of identification marks may be arranged. The identification mark may include a long-range identification mark 1115 which is easily identified at a long distance and a short-range identification mark 1117.

The unmanned aerial vehicle 100 may photograph the identification mark of the station 1100 with a camera, etc., analyze size, location, and direction information of the identification mark, and calculate a location of the unmanned aerial vehicle 100 and a distance between the unmanned aerial vehicle 100 and the station 1100.

The present disclosure may be a computer program including each step of a control method, or may be a recording medium on which a program for implementing a control method by a computer is recorded. The ‘recording medium’ indicates a computer-readable recording medium. The present disclosure may be an aerial control system including both hardware and software.

Each step of flow charts illustrating the control method and combinations of the flow charts may be performed by computer program instructions. The instructions may be mounted on a general purpose computer or a special purpose computer, etc., and may create means performing functions described in step(s) of the flow chart.

In some embodiments, the functions mentioned in the steps may occur out of order. For example, two successively illustrated steps may be actually performed substantially at the same time, or may be sometimes performed in reverse order depending on the corresponding functions.

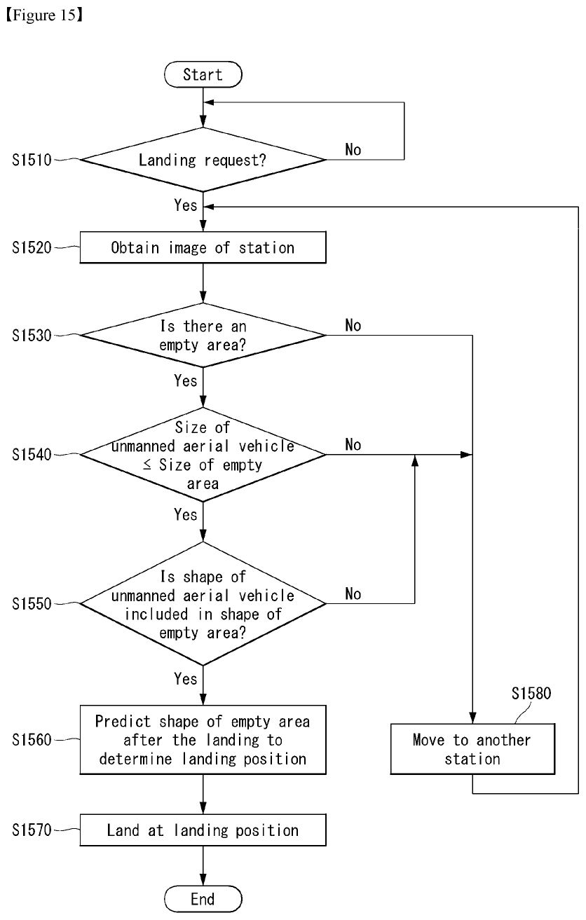

FIG. 15 is a flow chart illustrating a method of controlling an unmanned aerial vehicle 100 according to an embodiment of the present disclosure.

Referring to FIG. 15, if a user commands an unmanned aerial vehicle 100 to fly, the unmanned aerial vehicle 100 starts to fly.

If the unmanned aerial vehicle 100 requests to land at a station 1100 by its own needs during the flying or the user commands the unmanned aerial vehicle 100 to land, the unmanned aerial vehicle 100 sends a signal that requests to land at the station, in S1510. Here, the case where the unmanned aerial vehicle 100 requests to land by its own needs may include a case of a low battery level, or a case of an emergency situation, or a case where the unmanned aerial vehicle 100 has completed its mission.

If the station 1100 receives a landing request signal, the station 1100 may send a landing allowance signal to the unmanned aerial vehicle 100 considering conditions of the station 1100. In this instance, the station 1100 may open a door of the station 1100 or turn on a light source of the station 1100. It is a matter of course that the station 1100 may send location information of the station 1100 together with the landing allowance signal.

After the unmanned aerial vehicle 100 approaches the station 1100 up to a predetermined distance, the unmanned aerial vehicle 100 controls a camera to obtain an image of the station 1100 in S1520.

A processor 140 of the unmanned aerial vehicle 100 analyzes the image obtained by the camera and controls a horizontal and vertical mobile propulsion device. The processor 140 analyzes the image of the station 1100, determines a landing area 1110 of the station 1100, and determines an empty area 1113 in the landing area 1110 in S1530.

The processor 140 compares a size of the empty area 1113 with a size of the unmanned aerial vehicle 100 and determines whether the unmanned aerial vehicle 100 is able to land in the empty area 1113 in S1540, S1550, and S1560.

Specifically, if the processor 140 determines that the empty area 1113 is not present, the processor 140 controls the unmanned aerial vehicle 100 to move to other station 1100 in S1580.

If the processor 140 determines that the empty area 1113 is present, the processor 140 compares a size of the empty area 1113 with a size of the unmanned aerial vehicle 100 in S1540 and determines whether the unmanned aerial vehicle 100 is able to land in the empty area 1113.

More specifically, if the size of the empty area 1113 is less than the size of the unmanned aerial vehicle 100, the processor 140 controls the horizontal and vertical mobile propulsion device so that the unmanned aerial vehicle 100 moves to another station 1100. Here, the size of the unmanned aerial vehicle 100 is a planar area of the unmanned aerial vehicle 100, and the size of the empty area 1113 is a planar area of the empty area 1113.

If the size of the empty area 1113 is larger than the size of the unmanned aerial vehicle 100, the processor 140 compares a shape of the unmanned aerial vehicle 100 with a shape of the empty area 1113 in S1550. If the shape of the unmanned aerial vehicle 100 is included in the shape of the empty area 1113, the processor 140 may determine a landing position in S1560. Here, the fact that the shape of the unmanned aerial vehicle 100 is included in the shape of the empty area 1113 means that a planar shape of the unmanned aerial vehicle 100 is included in a planar shape of the empty area 1113. If the shape of the unmanned aerial vehicle 100 is not included in the shape of the empty area 1113, the processor 140 controls the unmanned aerial vehicle 100 to move to another station 1100 in S1580.

The processor 140 predicts the size and the shape of the empty area 1113 after the landing of the unmanned aerial vehicle 100 to determine a landing position. Specifically, the processor 140 determines the landing position of the unmanned aerial vehicle 100 considering the size and the shape of the unmanned aerial vehicle 100 waiting to land. More specifically, if the size of the empty area 1113 is larger than the size of the unmanned aerial vehicle 100, the processor 140 may control the horizontal and vertical mobile propulsion device so that the unmanned aerial vehicle 100 lands adjacent to an edge of the empty area.

The processor 140 controls the horizontal and vertical mobile propulsion device and lands the unmanned aerial vehicle 100 at the landing position in S1570. Specifically, if the processor 400 determines that the unmanned aerial vehicle 100 is able to land in the empty area 1113, the processor 140 controls the horizontal and vertical mobile propulsion device and controls the unmanned aerial vehicle 100 to land in the empty area 1113.

Hence, the unmanned aerial vehicle 100 can select the landing position at the station 1100 using only the image obtained by the camera, and a plurality of unmanned aerial vehicles 100 can efficiently use the space of the landing area 1110 of the station 1100.

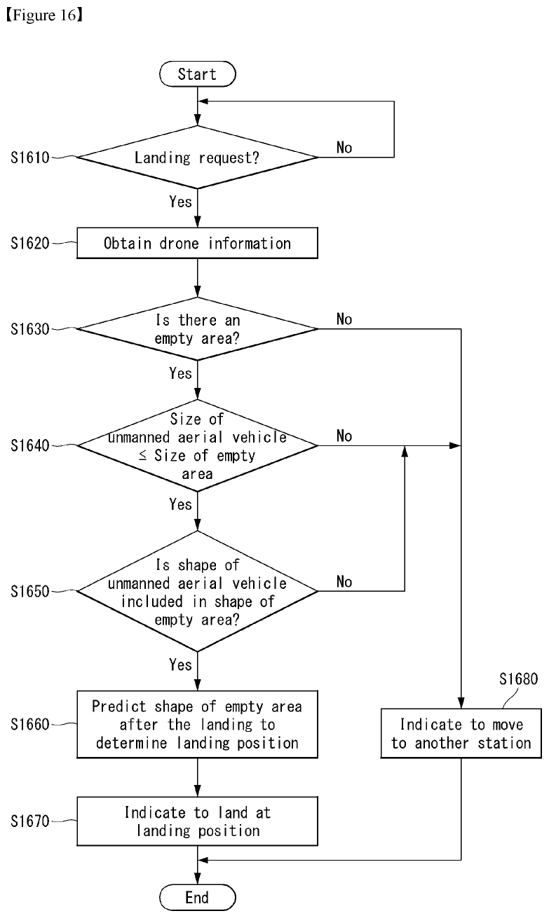

FIG. 16 is a flow chart illustrating a method of controlling an aerial control system according to an embodiment of the present disclosure.

Referring to FIG. 16, if a user commands an unmanned aerial vehicle 100 to fly, the unmanned aerial vehicle 100 starts to fly.

If the unmanned aerial vehicle 100 requests to land at a station 1100 by its own needs during the flying or the user commands the unmanned aerial vehicle 100 to land, the unmanned aerial vehicle 100 sends a signal that requests to land at the station, in S1610.

If the station 1100 receives a landing request signal, the station 1100 may send a landing allowance signal to the unmanned aerial vehicle 100 in consideration of conditions of the station 1100. In this instance, the station 1100 may open a door of the station 1100 or turn on a light source of the station 1100. It is a matter of course that the station 1100 may send location information of the station 1100 together with the landing allowance signal.

The control unit 240 obtains information of a drone in S1620. Specifically, the unmanned aerial vehicle 100 may send together information of the drone while sending a landing request to the station 1100. Here, information of the drone may include at least one of size information of the drone, shape information of the drone, battery level information of the drone, flight schedule of the drone, and luggage information of the drone.

The station 1100 determines an empty area 1113 in a landing area 1110 in S1630. Specifically, the control unit 240 determines the empty area 1113 based on information sensed by an area sensing sensor, and controls a communication unit to send a control signal to the unmanned aerial vehicle 100.

The control unit 240 compares a size of the empty area 1113 with a size of the unmanned aerial vehicle 100 and determines whether the unmanned aerial vehicle 100 is able to land in the empty area 1113 in S1640, S1650, and S1660.

Specifically, if the control unit 240 determines that the empty area 1113 is not present, the control unit 240 may control the communication unit to send a movement command, that instructs the unmanned aerial vehicle 100 to move to other station 1100, and location information of the other station 1100 to the unmanned aerial vehicle 100 in S1680.

If the control unit 240 determines that the unmanned aerial vehicle 100 is able to land in the empty area 1113, the control unit 240 may control the communication unit to send a landing command to the unmanned aerial vehicle 100. The landing command may include location information on the empty area 1113.

If the control unit 240 determines that the empty area 1113 is present, the control unit 240 compares a size of the empty area 1113 with a size of the unmanned aerial vehicle 100 in S1640 and determines whether the unmanned aerial vehicle 100 is able to land in the empty area 1113. The control unit 240 may determine whether the unmanned aerial vehicle 100 is able to land in the empty area 1113 based on shape information and size information of the unmanned aerial vehicle 100 received from the unmanned aerial vehicle 100.

More specifically, if the size of the empty area 1113 is less than the size of the unmanned aerial vehicle 100, the control unit 240 may send a movement command, that instructs the unmanned aerial vehicle 100 to move to other station 1100. The movement command may include location information of the other station 1100.

Here, the size of the unmanned aerial vehicle 100 indicates a planar area of the unmanned aerial vehicle 100, and the size of the empty area 1113 indicates a planar area of the empty area 1113.

If the size of the empty area 1113 is larger than the size of the unmanned aerial vehicle 100, the control unit 240 compares a shape of the unmanned aerial vehicle 100 with a shape of the empty area 1113 in S1650. If the shape of the unmanned aerial vehicle 100 is included in the shape of the empty area 1113, the control unit 240 may determine a landing position in S1660. Here, the fact that the shape of the unmanned aerial vehicle 100 is included in the shape of the empty area 1113 means that a planar shape of the unmanned aerial vehicle 100 may be included in a planar shape of the empty area 1113. If the shape of the unmanned aerial vehicle 100 is not included in the shape of the empty area 1113, the control unit 240 sends a movement command, that instructs the unmanned aerial vehicle 100 to move to other station 1100, and location information of the other station 1100 to the unmanned aerial vehicle 100 in S1680.

The control unit 240 predicts the size and the shape of the empty area 1113 after the landing of the unmanned aerial vehicle 100 to determine a landing position. Specifically, the control unit 240 determines the landing position of the unmanned aerial vehicle 100 considering the size and the shape of the unmanned aerial vehicle 100 waiting to land.

The control unit 240 controls a horizontal and vertical mobile propulsion device to land the unmanned aerial vehicle 100 at the landing position in S1670.

In case of a plurality of unmanned aerial vehicles 100, the control unit 240 may determine landing order of the plurality of unmanned aerial vehicles 100 considering various conditions.

For example, the control unit 240 may determine whether to land first an unmanned aerial vehicle 100 with a low battery level among the plurality of unmanned aerial vehicles 100 in the empty area 1113. As another example, the control unit 240 may determine whether to land first an unmanned aerial vehicle 100 with a large amount of luggage among the plurality of unmanned aerial vehicles 100 in the empty area 1113.

As another example, the control unit 240 may determine whether to land first an emergency unmanned aerial vehicle 100 among the plurality of unmanned aerial vehicles 100 in the empty area 1113. As another example, the control unit 240 may determine whether to land first an unmanned aerial vehicle 100 with many flight schedules among the plurality of unmanned aerial vehicles 100 in the empty area 1113.

Overview of Device to which the Present Disclosure is Applicable

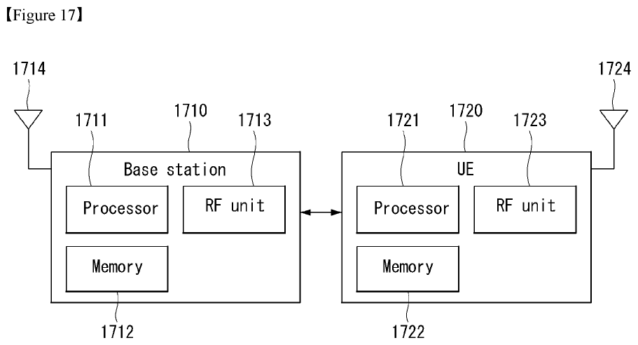

FIG. 17 illustrates a block configuration diagram of a wireless communication device according to an embodiment of the present disclosure.

Referring to FIG. 17, a wireless communication system includes a base station (or network) 1710 and a terminal 1720.

Here, examples of the terminal may include a user equipment (UE), a unmanned aerial vehicle (UAV), a drone, a wireless aerial robot, and the like.

The base station 1710 includes a processor 1711, a memory 1712, and a communication module 1713.

The processor 1711 implements functions, processes, and/or methods proposed in FIGS. 1 to 16. Layers of wired/wireless interface protocol may be implemented by the processor 1711. The memory 1712 is connected to the processor 1711 and stores various types of information for driving the processor 1711. The communication module 1713 is connected to the processor 1711 and transmits and/or receives wired/wireless signals.

The communication module 1713 may include a radio frequency (RF) unit for transmitting/receiving a radio signal.

The UE 1720 includes a processor 1721, a memory 1722, and a communication module (or RF unit) 1723. The processor 1721 implements functions, processes, and/or methods proposed in FIGS. 1 to 16. Layers of a radio interface protocol may be implemented by the processor 1721. The memory 1722 is connected to the processor 1721 and stores various types of information for driving the processor 1721. The communication module 1723 is connected to the processor 1721 and transmits and/or receives a radio signal.

The memories 1712 and 1722 may be inside or outside the processors 1711 and 1721 and may be connected to the processors 1711 and 1721 through various well-known means.

Further, the base station 1710 and/or the UE 1720 may have a single antenna or multiple antennas.

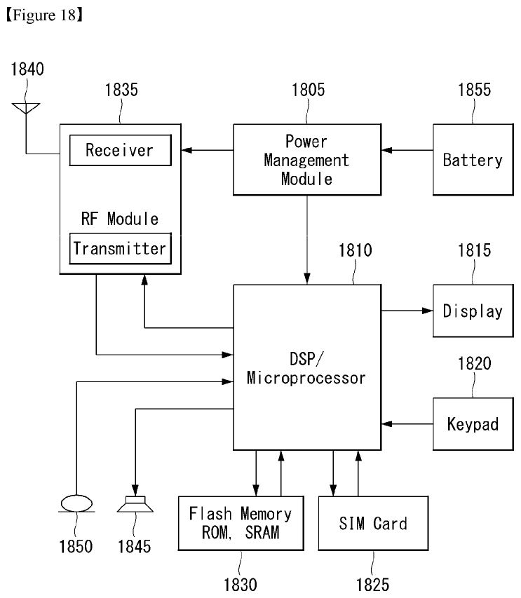

FIG. 18 illustrates a block configuration diagram of a communication device according to an embodiment of the present disclosure.

In particular, FIG. 18 illustrates in more detail the UE illustrated in FIG. 17.

Referring to FIG. 18, the UE may include a processor (or digital signal processor (DSP)) 1810, an RF module (or RF unit) 1835, a power management module 1805, an antenna 1840, a battery 1855, a display 1815, a keypad 1820, a memory 1830, a subscriber identification module (SIM) card 1825 (which is optional), a speaker 1845, and a microphone 1850. The UE may also include a single antenna or multiple antennas.

The processor 1810 implements functions, processes, and/or methods proposed in FIGS. 1 to 17. Layers of a radio interface protocol may be implemented by the processor 1810.

The memory 1830 is connected to the processor 1810 and stores information related to operations of the processor 1810. The memory 1830 may be inside or outside the processor 1810 and may be connected to the processors 1810 through various well-known means.

A user inputs instructional information, such as a telephone number, for example, by pushing (or touching) buttons of the keypad 1820 or by voice activation using the microphone 1850. The processor 1810 receives and processes the instructional information to perform an appropriate function, such as to dial the telephone number. Operational data may be extracted from the SIM card 1825 or the memory 1830. Further, the processor 1810 may display instructional information or operational information on the display 1815 for the user's reference and convenience.

The RF module 1835 is connected to the processor 1810 and transmits and/or receives an RF signal. The processor 1810 forwards instructional information to the RF module 1835 in order to initiate communication, for example, transmit a radio signal configuring voice communication data. The RF module 1835 includes a receiver and a transmitter to receive and transmit the radio signal. The antenna 1840 functions to transmit and receive the radio signal. Upon reception of the radio signal, the RF module 1835 may transfer a signal to be processed by the processor 1810 and convert the signal into a baseband. The processed signal may be converted into audible or readable information output via the speaker 1845.

The embodiments described above are implemented by combinations of components and features of the present disclosure in predetermined forms. Each component or feature should be considered selectively unless specified separately. Each component or feature may be carried out without being combined with another component or feature. Moreover, some components and/or features are combined with each other and can implement embodiments of the present disclosure. The order of operations described in embodiments of the present disclosure may be changed. Some components or features of one embodiment may be included in another embodiment, or may be replaced by corresponding components or features of another embodiment. It is apparent that some claims referring to specific claims may be combined with another claims referring to the claims other than the specific claims to constitute the embodiment or add new claims by means of amendment after the application is filed.

Embodiments of the present disclosure can be implemented by various means, for example, hardware, firmware, software, or combinations thereof. When embodiments are implemented by hardware, one embodiment of the present disclosure can be implemented by one or more application specific integrated circuits (ASICs), digital signal processors (DSPs), digital signal processing devices (DSPDs), programmable logic devices (PLDs), field programmable gate arrays (FPGAs), processors, controllers, microcontrollers, microprocessors, and the like.

When embodiments are implemented by firmware or software, one embodiment of the present disclosure can be implemented by modules, procedures, functions, etc. performing functions or operations described above. Software code can be stored in a memory and can be driven by a processor. The memory is provided inside or outside the processor and can exchange data with the processor by various well-known means.

It is apparent to those skilled in the art that the present disclosure can be embodied in other specific forms without departing from essential features of the present disclosure. Accordingly, the aforementioned detailed description should not be construed as limiting in all aspects and should be considered as illustrative. The scope of the present disclosure should be determined by rational construing of the appended claims, and all modifications within an equivalent scope of the present disclosure are included in the scope of the present disclosure.

### INDUSTRIAL APPLICABILITY

Although a method of landing a drone according to the present disclosure has been described focusing on examples applying to the 3GPP LTE/LTE-A system and the 5G system, it can be applied to various wireless communication systems other than them.

1. An unmanned aerial robot comprising:
a camera configured to obtain an image of a station;
a horizontal and vertical mobile propulsion device configured to horizontally and vertically move the unmanned aerial vehicle;
a transmitter configured to transmit a radio signal;
a receiver configured to receive an uplink (UL) grant and a downlink (DL) grant; and
a processor configured to:
determine a landing area of the station through the image of the station;
compare a size of an empty area of the landing area with a size of the unmanned aerial robot; and
determine whether the unmanned aerial robot is able to land in the empty area.

2. The unmanned aerial robot of claim 1, wherein if the processor determines that the unmanned aerial robot is able to land in the empty area, the processor causes the unmanned aerial robot to land in the empty area through the horizontal and vertical mobile propulsion device.

3. The unmanned aerial robot of claim 1, wherein if the processor determines that the unmanned aerial robot is unable to land in the empty area, the processor causes the unmanned aerial robot to move to another station through the horizontal and vertical mobile propulsion device.

4. The unmanned aerial robot of claim 1, wherein a size of the empty area changes based on the size of the unmanned aerial robot.

5. The unmanned aerial robot of claim 1, wherein the processor determines whether the unmanned aerial robot is able to land in the empty area based on a planar shape and a planar area of a direction in which the unmanned aerial robot meets a ground.

6. The unmanned aerial robot of claim 5, wherein if a planar shape of the empty area is larger than the planar area of the direction in which the unmanned aerial robot meets the ground, the processor causes the unmanned aerial robot to land adjacent to an edge of the empty area through the horizontal and vertical mobile propulsion device.

7. A landing method comprising:
obtaining an image of a station to land;
determining whether am empty area for landing is present in the station based on the image;
if the empty area is present, comparing a size of the empty area with a size of an unmanned aerial robot to determine whether the landing is possible in the empty area; and
if the landing is possible in the empty area, performing the landing adjacent to an edge of the empty area,
wherein a size of the empty area changes based on the size of the unmanned aerial robot.

8. The landing method of claim 7, further comprising:
transmitting a landing request signal to the station; and
receiving, from the station, a landing allowance signal as a response to the landing request signal,
wherein the station prepares the landing of the unmanned aerial robot based on the landing request signal.

9. The landing method of claim 8, further comprising receiving, from a network, downlink control information (DCI) used to schedule a transmission of the landing request signal,
wherein the landing request signal is transmitted to the station through the network based on the DCI.

10. The landing method of claim 7, further comprising, if the landing is impossible in the empty area, receiving, from a server, a movement command indicating to move to another station.

11. The landing method of claim 10, wherein the server manages size information of the unmanned aerial robot.

12. The landing method of claim 11, wherein the server determines whether the unmanned aerial robot is able to land in the empty area, based on the size information.

13. The landing method of claim 10, wherein the server compares a planar shape and a planar area of a direction, in which the unmanned aerial robot meets a ground, with a planar shape and a planar area of the empty area to determine whether the unmanned aerial robot is able to land in the empty area.

14. The landing method of claim 12, wherein if a size of the empty area is larger than a size of the unmanned aerial robot, the server sends a command that instructs the unmanned aerial robot to land adjacent to an edge of the empty area.

15. The landing method of claim 7, further comprising, if the station is unable to be recognized based on the image, transmitting a signal indicating to supply light for recognizing the station,
wherein the station includes a light source for the light supply and operates the light source based on the signal.

16. The landing method of claim 7, further comprising, if the station is unable to be recognized based on the image, transmitting a signal indicating to operate a fan for recognizing the station,
wherein the station includes the fan for blowing air to a surface of the station and operates the fan based on the signal.

17. The landing method of claim 7, whether the landing is possible in the empty area based on a battery remaining amount of the unmanned aerial robot.

18. The landing method of claim 7, whether the landing is possible in the empty area based on an amount of luggage of the unmanned aerial robot.

19. The landing method of claim 7, whether the landing is possible in the empty area based on emergency status information of the unmanned aerial robot.

20. The landing method of claim 7, whether the landing is possible in the empty area based on a flight schedule of the unmanned aerial robot.
